(19) United States
(12) Patent Application Publication
(10) Pub. No.: US 2025/0137926 A1
(43) Pub. Date: May 1, 2025

(54) SYSTEM AND METHOD FOR REMOTE IMAGING OF GREENHOUSE GAS EMISSIONS

(71) Applicant: GEOTEKNICA CLIMATE CHANGE SOLUTIONS INC., Victoria (CA)

(72) Inventors: Thomas Edward DARCIE, Victoria (CA); Robert Levi SMITH, Victoria (CA); Nikolay Nikolov TZONEV, Victoria (CA)

(73) Assignee: GEOTEKNICA CLIMATE CHANGE SOLUTIONS INC., Victoria, BC (CA)

(21) Appl. No.: 18/837,060

(22) PCT Filed: Feb. 10, 2023
(86) PCT No.: PCT/CA2023/050177

§ 371 Date: Aug. 8, 2024

Related U.S. Application Data
(60) Provisional application No. 63/309,020, filed on Feb. 11, 2022.

(51) Int. Cl. G01N 21/39; G01N 21/17; G01S 7/481; G01S 7/4911; G01S 7/4912; G01S 7/499; G01S 17/34; G01S 17/42; G01S 17/89; G01S 17/95

(52) U.S. Cl. CPC G01N 21/39; G01S 7/4817; G01S 7/4911; G01S 7/4917; G01S 7/499; G01S 17/34; G01S 17/42; G01S 17/89; G01S 17/95; G01N 2021/1795

(57) ABSTRACT

A system and method for imaging gas emissions is provided which may include a laser transmitter responsive to a first and second control signals to produce a frequency-modulated continuous-wave (FMCW) first optical output, an optical routing network configured to accept the first optical output and route at least a first portion to an optical receiver, and a controller programmed to generate the second control signal, respond to input from the wavelength reference unit to generate the first control signal and deliver the first control signal to the laser transmitter, and to calculate, using the second control signal and input from the optical receiver, a path absorption.

### FIELD OF THE INVENTION

The invention relates to the field of greenhouse gas emissions, and in particular, to a system and method for remote imaging of greenhouse gas emissions

### BACKGROUND OF THE INVENTION

Emissions of greenhouse gasses from human-related activities are a major contributor to climate change, spawning international efforts to reduce emissions by at least 30 percent from 2020 levels by 2030. Participants intend to use best available methodologies to detect and quantify emissions, with a particular focus on high-emission sources. However, at present, commercially-available emission detection technologies do not support an economical rollout of large-scale emissions monitoring. Urgent innovation in this field is crucial for the success of these climate change mitigation efforts, and hence the future of the planet. Therefore, development of effective and economic solutions for continuous gas emissions monitoring is an important problem.

Methane emissions are of particular concern (e.g., https://www.epa.gov/ghgemAissions/overview-greenhouse-gases). Although methane accounts for only 10% of the overall human-attributable emissions, the direct Global Warming Potential (GWP) for methane is 26-38 times greater than the GWP of CO2. As methane disintegrates within 12 years in the atmosphere, it creates precursors for ozone which itself is a powerful greenhouse gas that leads to an overall GWP of 80 for methane.

As the effects of global warming continue to escalate in severity, dramatically reducing methane emissions from human activity has become one of the focal points in the battle against climate change.

Depending on the industry, reduction of methane emissions would either entail identification and repair of methane escape sources or methane detection and sequestration from process. In any case, the presence and concentration of methane needs to be reliably identified, preferably in real time.

Methane is a colorless, odorless gas that is lighter than air and becomes lighter as the ambient temperature increases. This enables rapid migration and dissipation driven by winds and solar activity. This complicates detection of methane sources and makes difficult real-time quantification of methane releases for the purpose of enforcement. Detecting methane presence and concentration at a specific location is not difficult and capable methane point-sensors have been available for decades. Detecting the size and composition of methane plumes, however, is an emerging field that remains somewhat stagnant primarily due to the complexity of technologies involved. It is within this landscape that the present invention provides innovative new systems and methods required to image gaseous emissions in near-real-time within acceptable costs and within operational constraints.

Imaging cameras for short-wavelength infra-red (SWIR, 1-2.5 um wavelength) and mid-WIR (MWIR, 2.5-5 um wavelength) are available, but these are expensive and unable to distinguish between constituent gasses in mixtures. These use arrays of narrow-band-gap semiconductor detectors with CCD-like charge accumulation and read-out circuitry to record a sequence of images of the field of view (FoV), imaged onto the array through lenses designed specifically for the wavelength band of interest. Since most gasses of interest have weak absorption even in for IR wavelengths, imaging the gasses generally requires detecting a small change relative to a large background signal. This can be facilitated by comparing two sets of images, separated by time or by splitting the screen, one with an optical bandpass filter passing the wavelength band of interest and the other without. This adds cost and complexity.

Another limitation is that the image recorded depends strongly on the illumination of the scene. Passive systems rely on ambient light to pass through the gas emission and this ambient light is highly variable, especially when comparing sunlight with night-time operation. Active systems require an intense light source in the appropriate wavelength band, sources that are problematic and no match for the intensity of direct or reflected sunlight.

Another limitation is that as wavelength increases from visible wavelengths through NIR, SWIR and ultimately MWIR, the photon energy decreases. The ratio of photon energy to thermal noise energy generated in the detectors thereby decreases. This thermal noise energy is kT, where k is the Boltzmann constant and T is the absolute temperature. Hence while detectors and detector arrays for short wavelengths have very low noise, low cost, and are massively deployed into billions of mobile device cameras, detectors and detector arrays for longer wavelengths are specially designed for low-volume markets, and limited in performance by detector noise. To reduce noise, the only option is to cool the detector to the lowest temperature practical, given constraints imposed by condensation, power consumption and cost. So, while effective imaging cameras are available for SWIR and MWIR applications, they are not suitable for imaging in widely-deployed low-cost monitoring applications in harsh environments.

For quantitative spectroscopic gas analysis, particularly where the focus has been on detection and analysis rather than imaging, several basic techniques have been used for decades, including wavelength-modulation spectroscopy (WMS), differential absorption Lidar (DIAL) and laser differential absorption spectroscopy (LDAS). Applications for these technologies are diverse, ranging from precision gas analysis in the lab to satellite-based spectroscopic measurements. In addition to measuring composition, the Lidar in DIAL can also measure wind velocity using Doppler techniques.

With each of these techniques, laser wavelengths are carefully tuned to specific spectroscopic features in the absorption spectrum of the targeted gas. The laser output is then passed through the gas sample where a small fraction is absorbed. Generally, the remaining light is reflected or scattered back towards the source, which is collocated with the receiver. The receiver then measures the reduction in received power of the double-passed path between the transmitter and receiver to determine integrated path absorption (IPA). To detect the small changes in received IPA signal in the presence of large background signals, it is advantageous if the detected IPA is calculated using a reference signal obtained by shifting the laser frequency (WMS) or switching to a laser with a frequency away from the absorption reference and taking the difference between the on- and off-resonance signals—hence the term “differential” in the names of these techniques.

Each of these techniques has unique requirements for lasers that can be switched or tuned to the appropriate wavelengths and modulated with the required intensity, frequency or phase signatures. High output power, low phase and intensity noise, operation at appropriate SWIR/MWIR wavelengths and appropriate thermal and mechanical properties are some common desirable properties. Laser diodes, particularly those designed for single-frequency (single longitudinal mode) operation, including distributed-feedback (DFB) or distributed-Bragg-reflector (DBR) diode lasers, borrow technology from the lasers used in telecommunications systems (wavelengths near 1550 nm) to offer small and efficient low-cost lasers for many frequencies of interest, but output powers are limited to roughly a few tens of mW, or less if fiber-coupled lasers are used.

If higher power is required and cost is less of a constraint, as is the case for space-based or long-range systems, two options are available: optical amplification and nonlinear optic frequency conversion schemes. For each of these options there exists a complex field of sophisticated technology. An optical parametric oscillator is an example of the latter in which photons from a high-power pump laser are split into two lower-energy photons (signal and idler) using a nonlinear optical crystal. Changing the orientation of the crystal changes the frequencies of the signal and idler, subject to conservation of power and momentum, such that the signal coincides with the spectral absorption feature of interest. These systems tend to be large, expensive and not suitable for deployment in remote and harsh environments. Optical amplification allows increasing modest signal powers in the range of mW by 20-30 dB, dramatically increasing the potential range or sensitivity of the analyser. Semiconductor amplifiers use the same basic technology as diode lasers, but without the laser resonator. These can provide around 100 mW output for significant cost, and add often-problematic noise and dynamic effects that must be considered. Fiber amplifiers, like the Erbium-doped fiber amplifiers (EDFAs) that have transformed the telecommunications industry, offer powers exceeding 1 W, but work only for specific wavelength ranges that do not coincide with most desired absorption features. Finally, fiber Raman amplification uses a nonlinear optical fiber to convert a strong pump signal at a wavelength typically 100 nm shorter (the Raman frequency shift) than the desired signal laser into gain at the signal wavelength. Powers in excess of 100 mW are achievable, but powerful pump lasers and several km of optical fiber are required. To summarize, there are numerous paths to high-power laser sources, but each introduces significant cost, size, mechanical and operational limitations, particularly in the context of rugged and low-cost monitoring systems. Eye safety must also be considered, which may limit operating powers to a few tens of mW.

For many applications in analysis, there is no need to obtain an image across a specified FoV, which allows the use of large-aperture collection optics (e.g., telescopes), which increases sensitivity and eliminates the requirement for a beam scanning apparatus. In addition, without the requirement for beam scanning, weak received signals can be integrated over greater times, also improving sensitivity. These techniques have been used widely for high-precision analysis of gasses and gas mixtures, providing composition, temperature, ranging and wind velocity, in lab, terrestrial, airborne and space-based environments, but the associated instruments are not suitable for imaging in widely-deployed low-cost monitoring applications.

Scanning Lidar systems have undergone substantial advancement over recent years, driven by innovation and applications in machine vision, industrial inspection and autonomous vehicles. Many types of laser scanners are available, including motor-driven polygonal rotating mirrors, piezo-electric transducers, and micro electro-mechanical systems (MEMS). Compatibility with silicon-photonic optical integration, small size, monolithic fabrication and long lifetime are strong advantages for MEMS, but a bandwidth-versus-mirror-size trade-off presents well-known limitations. Nevertheless, MEMS offer an attractive path for widely-deployable laser vision Lidar systems required for near-real-time 3D imaging and ranging.

Lidar systems fall into two primary categories, time domain and frequency domain. In time-domain systems, a laser is modulated to produce sequence of short pulses. A scanning system and projection optics project these pulses into the FoV and the reflected or backscattered signals are detected using a broadband optical receiver. The distance to the scattering object is calculated from the time delay between the transmitted and received pulses, providing a near-real-time 3D image of the FoV. Alternatively, with the frequency-domain technique entitled frequency-modulation continuous-wave (FMCW) Lidar, the laser frequency is modulated to produce typically a triangular or saw-tooth frequency-versus-time waveform, which is scanned across the FoV. The returning backscattered signal is compared to the transmitted signal using, for example, a coherent optical receiver, which provides the frequency difference, and this frequency difference is used to calculate the distance to the target or scattering surface. Frequency-domain Lidar can also be implemented with direct optical detection using microwave sub-carrier modulation by encoding a typically triangular frequency-versus-time waveform into the microwave signal that is used to intensity modulate a laser.

Each technique, time or frequency, has strengths and weaknesses. Time-domain systems and microwave subcarrier systems are generally simpler, allow for larger optical receiver apertures and can use less complex multi-mode lasers, making them more amenable to parallelism, but require short pulses, RF components and higher bandwidths. Coherent frequency-domain FMCW systems require single-frequency (e.g., distributed feedback) lasers, optical mode control, which limits the receiver aperture area, and polarization control, but electrical bandwidths are reduced and coherent detection offers high sensitivity and spectral selectivity.

Most Lidar applications operate in visible or near infrared wavelengths where a significant benefit is realized from the use of low-noise detectors and detector arrays. Unlike LDAS, WMS and DIAL, there is no need to control laser frequencies to align with specific spectral features. Also, silicon-photonic optical integration enables monolithic fabrication of highly parallelized circuits comprising hundreds of lasers and detectors. As a result, we anticipate the emergence of a large Lidar industry. However, these factors do not apply when operating at SWIR or MWIR wavelengths where gasses of interest have useable absorption.

Combining LDAS/DIAL/WMS gas analysis with scanning Lidar Systems is an attractive path for imaging fugitive gasses and has been the subject of considerable published prior art. Note that the focus of a Lidar system is to generate precise ranging information, whereas for monitoring gas emissions we are concerned primarily with IPA. While knowing the range to the background scattering object from which the IPA is determined may be useful for identifying the source of a leak or quantifying the leak rate, this distance measurement is generally not the intent of the IPA measurement and is of secondary importance.

Despite an abundance of prior art, key limitations remain in developing high-performance and operationally-effective solutions. Performance is limited fundamentally by the extremely weak signals backscattered from a background, since gasses of interest are invisible and do not scatter significant electromagnetic radiation themselves, and by the weak absorption of low concentrations of fugitive emissions. Methane, for example, has relatively strong absorption near 3.2 um, but the cost of components required to operate in MWIR wavelengths is high and the performance is poor. Technology required to operate near 1.6 um is relatively affordable and performs well, but absorption at these wavelengths is very weak. Three main approaches are employed by prior art. First, accept the cost and performance challenges and operate at MWIR wavelengths (e.g., 3.2 um) where absorption is higher. Second, SWIR wavelengths can be used near 1.6 um, where absorption is weaker but the optical technology is less costly and higher in performance, and build extremely sensitive receivers to detect very weak signals. Third, use special lasers or optical amplifiers to increase the level of signals transmitted and received. Existing solutions use one of more of these approaches, as discussed in more depth below, resulting in high-performance systems that can image fugitive gasses over long distances along the ground or from above using drones or aircraft. However, these systems are very costly and suffer from significant operational limitations.

Operational limitations arise from the harsh environment generally surrounding oil and gas facilities or other sources of gas emission. Technology deployed in these locations must survive wide temperature ranges, high winds, dust, vibration, blizzard conditions and more. Facilities are often complex structures in which clear sight paths are occluded by structures, topography or vegetation. A long-range high-performance imaging system cannot be expected to cover the required FoV. Additional infrastructure like towers, reflectors, power and communications cabling, etc., are problematic. It is desired to monitor continuously, raising alarms when thresholds are exceeded. Periodic imaging fly-overs from an aerial platform do not offer continuous monitoring. False alarms, positive or negative, are not tolerated.

Of the various gas imaging approaches outlined previously, tunable diode laser absorption spectroscopy (TDLAS or LDAS) and wavelength-modulation spectroscopy (WMS), as summarized by Stewart (G. Stewart, “Laser and fiber optic gas absorption spectroscopy,” Cambridge University Press, U. K., 2021), are closely related. To achieve high sensitivity for weak received optical signals, these systems use large receiver apertures and sensitive direct-detection receivers. For 3D gas mapping, a WMS system can be combined with another spatial encoding technique that provides range information (A. T. Kreitinger, M. J. Thorpe, “High sensitivity gas-mapping 3D imager and method of operation,” U.S. Pat. No. 11,105,621 B2, Aug. 31, 2021), which also describes the unsuitability of FMCW Lidar for scanning WMS gas analysis.

Differential absorption Lidar (DIAL) combines frequency-dependent absorption techniques with light backscatter detection and ranging of pulsed or continuous wave (CW) Lidar. The large majority of these systems use direct detection with large receiver apertures to capture as much light as possible (e.g., J. Titchener and X. Ai, “Rapidly tuneable diode Lidar,” UK Patent Application GB 2586075 A, Mar. 2, 2021). Single-photon detection (SPD) techniques, in which avalanche photodetectors are operated in Geiger mode to produce large electrical pulses in response to single photons, are also used to boost sensitivity. Combined with high-speed time gating and correlation of the optical signals, SPD provides high receiver sensitivity, but with significant cost and complexity. To reduce unwanted thermally activated avalanche events, which manifest as noise, detectors are often cooled (e.g., to −50° C.) increasing cost and power consumption. One of the largest drawbacks is that the scanning systems and optical apparatus required to scan this large optical aperture over a large FoV may be large and slow.

Another example of prior art is a sophisticated space-based detector for water vapor (V. Wulfmeyer and C. Walther, “Future performance of ground-based and airborne water-vapor differential absorption Lidar,” Applied Optics, Vol. 40, No. 30, 20 Oct., 2001) where it is concluded that coherent optical detection should not be used in favor of direct detection.

Nevertheless, coherent DIAL-Lidar systems have been demonstrated. Coherent detection uses a local laser (local oscillator or LO) and square-law detection in typically a balanced photodetector comprising two photodetectors to down-convert modulation information on an optical carrier to microwave frequencies, as will be discussed in detail later. This powerful technique has been used for decades and has become the backbone of modern optical communications networks as well as a clear contender for scanning Lidar systems. However, several well-understood challenges have limited its application in gas imaging. In particular, the polarizations and spatial modes of the LO and returning signal must be matched on the detector. This places strong constraints on collection efficiency of the backscattered signal through a scanning system, limiting the size of the receiver aperture and hence the amount of received light.

An example of coherent Lidar for CO2 detection (F. Gilbert et al., “Two-micrometer heterodyne differential absorption Lidar measurements of the atmospheric CO2 mixing ratio in the boundary layer,” Applied Optics, Vol. 45, No. 18, 20 Jun., 2006) demonstrates the complexity and performance challenges associated with long-range coherent detection. A recent example (N. Cezard, et al., “Performance assessment of a coherent DIAL-Doppler fiber Lidar at 1645 nm for remote sensing of methane and wind,” Optics Express, Vol. 28, No. 15, 22345, 20 Jul., 2020) describes a complex instrument, switching between two source lasers, using Raman fiber amplification and using a motorized scanning mirror. Both examples switch between two lasers to provide on- and off-resonance frequencies, and use pulsed modulation for Lidar. To summarize, without constraints on cost, scanning speed and size, and with strong emphasis on achieving ultimate performance, large optical apertures and direct detection are more desirable than coherent detection.

Much of the recent innovation in Lidar is driven by applications in autonomous vehicles, robot and computer vision, and industrial inspection—applications that are far more cost and size sensitive than the gas analysis systems described above. These high-volume applications require fast scanning for real-time 3D imaging over a wide FoV. Large apertures are often not practical, making coherent detection an important tool for increasing receiver sensitivity. As with DIAL, large aperture size is important in detecting weak signals, but this is balanced by stronger constraints on scanning speed and physical size. Direct detection allows increased aperture diameters by de-coupling the requirement imposed by coherent detection for matched transmit and receive spatial modes (for example, R. Moss et al., “Low-cost compact MEMS scanning LADAR system for robotic applications,” Laser Radar Technology and Applications XVII, edited by M. D. Turner, G. W. Kamerman, Proc. of SPIE Vol. 8379, 837903, 2012), but this advantage is offset by the much higher receiver sensitivity possible with coherent detection.

Of particular relevance to the present invention is FMCW Lidar, a technique that has evolved from early work on heterodyne radar to include pioneering work on optical systems in the late 1900s (for example, C. M. Sonnenschein and F. A. Horrigan, “Signal-to-noise ratio for coaxial systems that heterodyne backscatter from the atmosphere,” Appl. Opt. 10, 1600-1604, 1971). European patent specification EU2817658B1 (D. Weidmann, “Heterodyne detection system and method,” 2015) describes coherent FMCW-like operation, but uses an acousto-optic modulator on the outgoing laser signal and not the LO, limiting the ranging functionality, and beam scanning is excluded. Recent publications that demonstrate the state-of-the-art in FMCW Lidar with coherent detection (for example, S. Cwalina, et al., “Fiber-based frequency modulated LiDAR with MEMS scanning capability for long-range sensing,” 2021 IEEE International Workshop on Metrology for Automotive) begin to show the possibility of compact and portable scanning Lidar systems, but not applied to gas imaging.

To summarize, there have been many aspects of prior art related to improving imaging systems for fugitive greenhouse gasses. Many impressive technical achievements have been researched and incorporated into available products, but the cost and complexity of these solutions do not support widespread, continuous and operationally-desirable deployment. Given these shortcomings with the prior art, and the importance of reducing greenhouse gas emissions, there is a compelling need for innovative solutions.

To the authors' knowledge, there are no reports of scanning FMCW Lidar using coherent detection for differential gas analysis. There are well-understood reasons for this—lessons learned from the WMS and DIAL systems described above and in the specific context of achieving the highest performance (e.g. range, sensitivity). However, a coherent system has strong advantages in other dimensions, such as physical size and scanning speed, though perhaps at the expense of performance. The present disclosure describes such systems and methods.

### SUMMARY OF INVENTION

According to an embodiment of the invention, there is provided a system and method for imaging gas emissions.

The system may include a laser transmitter responsive to a first control signal to maintain operation nominally at a predetermined optical frequency and a second control signal to produce a frequency-modulated continuous-wave (FMCW) first optical output. The system may also include an optical routing network configured to accept the first optical output and route at least a first portion to an optical receiver, a second portion to a wavelength reference unit and a third portion to a beam scanner, and to accept a return signal from the beam scanner and deliver it to the optical receiver. Additionally, the system may include a controller programmed to generate the second control signal, respond to input from the wavelength reference unit to generate the first control signal and deliver the first control signal to the laser transmitter, and to calculate, using the second control signal and input from the optical receiver, a path absorption.

The method may include providing a laser transmitter responsive to a first control signal to maintain operation nominally at a predetermined optical frequency and a second control signal to produce a frequency-modulated continuous-wave (FMCW) first optical output. The method may also include providing an optical routing network, a coherent optical receiver and a beam scanner, the optical routing network configured to accept the first optical output and route at least a first portion to the coherent optical receiver and a second portion to the beam scanner, to accept a return signal from the beam scanner, and to combine at least a portion of the first portion and the return signal and deliver the combination to the coherent optical receiver, wherein the coherent optical receiver is operable to convert input optical signals into a first electrical signal output. The method may also include providing a controller programmed to generate the first control signal and to accept the first electrical signal output from the coherent optical receiver, and to calculate, using the first electrical signal from the coherent optical receiver, a path absorption.

The FMCW first optical output may be generated using direct modulation of the current injected into a laser diode. The FMCW first optical output may also be generated using external modulation of a continuous-wave laser.

The external modulation of a continuous-wave laser may be implemented using an acousto-optic frequency modulator.

The first control signal may be nominally a triangle or saw-tooth waveform. The first control signal may also be nominally a sinusoidal waveform. The first control signal may be the sum of a finite number of Fourier frequency components and wherein the amplitude and phase of each component is adjusted to compensate for laser characteristics.

The controller may also programmed to compute, using the signal from the coherent optical receiver, the range to the scattering background. In calculating a path absorption, the controller may measure the amplitude, envelope or root-mean square of the first electrical signal output from the coherent optical receiver.

According to another embodiment of the invention, there is provided a system and method for imaging gas emissions.

The system may include a laser transmitter responsive to a first control signal to produce a frequency-modulated continuous-wave (FMCW) first optical output and a second control signal to maintain operation nominally at a predetermined optical frequency. The system may also include an optical routing network configured to accept the first optical output and route at least a first portion to a coherent optical receiver, a second portion to a beam scanner, a third portion to a wavelength reference unit and to accept a return signal from the beam scanner, to combine at least a portion of the first portion and the return signal and deliver the combination to the coherent optical receiver wherein the coherent optical receiver is operable to convert input optical signals into a first electrical signal output. A second optical receiver may be provided within the wavelength reference unit operable to convert the third portion of the first optical output into a wavelength reference signal. The system may also include a controller programmed to generate the first control signal, to accept the wavelength reference signal from the wavelength reference unit, generate the second control signal and deliver the second control signal to the laser transmitter, to accept the first electrical signal output from the coherent optical receiver, and to calculate, using the signal from the coherent optical receiver, a path absorption.

The method may include providing a laser transmitter responsive to a first control signal to produce a frequency-modulated continuous-wave (FMCW) first optical output and a second control signal to maintain operation nominally at a predetermined optical frequency. The method may also include providing an optical routing network, a coherent optical received and a beam scanner, the optical routing network configured to accept the first optical output and route at least a first portion to the coherent optical receiver, a second portion to the beam scanner, a third portion to a wavelength reference unit and to accept a return signal from the beam scanner, to combine at least a portion of the first portion and the return signal and deliver the combination to the coherent optical receiver wherein the coherent optical receiver is operable to convert input optical signals into a first electrical signal output. The method may also include providing an optical receiver within the wavelength reference unit operable to convert the third portion of the first optical output into a wavelength reference signal. The method may also include providing a controller programmed to generate the first control signal, to accept the wavelength reference signal from the wavelength reference unit, generate the second control signal and deliver the second control signal to the laser transmitter, to accept the first electrical signal output from the coherent optical receiver, and to calculate, using the signal from the coherent optical receiver, a path absorption.

The second control signal may be used to maintain operation at an optical frequency corresponding to a predetermined spectral feature of a gas absorption spectrum. The predetermined spectral feature may correspond to an inflection point in the absorption-versus-frequency transfer function. The predetermined spectral feature may also correspond to a peak in the absorption-versus-frequency transfer function.

In generating the second control signal, the controller may compare the signals at the FMCW modulation frequency and at 2 times the FMCW modulation frequency.

The wavelength reference unit may comprise a sample of the gas that is to be imaged.

According to another embodiment of the invention, there is provided a system and method for imaging gas emissions.

The system may include a laser transmitter responsive to a first control signal to produce a frequency-modulated continuous-wave (FMCW) first optical output. The system may also include an optical routing network configured to accept the first optical output and route at least a first portion to a coherent optical receiver, a second portion to a beam scanner, and to accept a return signal from the beam scanner, to combine at least a portion of the first portion and the return signal and deliver the combination to the coherent optical receiver, wherein the coherent optical receiver is operable to convert input optical signals into a first electrical signal output. The system may also include a controller programmed to generate the first control signal, to accept the first electrical signal output from the coherent optical receiver and to calculate, using the first electrical signal output from the coherent optical receiver, a path absorption and range, where, in calculating the path absorption, the controller compares the signal from the coherent receiver at different times within at least one period of the FMCW first optical output.

The method may include providing a laser transmitter responsive to a first control signal to produce a frequency-modulated continuous-wave (FMCW) first optical output. The method may also include providing an optical routing network, a coherent optical receiver and a beam scanner, the optical routing network configured to accept the first optical output and route at least a first portion to the coherent optical receiver, a second portion to the beam scanner, and to accept a return signal from the beam scanner, to combine at least a portion of the first portion and the return signal and deliver the combination to the coherent optical receiver, wherein the coherent optical receiver is operable to convert input optical signals into a first electrical signal output. The method may also include providing a controller programmed to generate the first control signal, to accept the first electrical signal output from the coherent optical receiver and to calculate, using the first electrical signal output from the coherent optical receiver, a path absorption and range, where, in calculating the path absorption, the controller compares the signal from the coherent receiver at different times within at least one period of the FMCW first optical output.

The amplitude of the signal from the coherent optical receiver may be used by the controller in calculating the path absorption.

The controller may further calculate the range to the scattering background using the signal from the coherent optical receiver corresponding to at least one time within at least one period of the FMCW first optical output.

The amplitude of the signal from the coherent optical receiver may is used by the controller when calculating the range.

The frequency of the signal from the coherent optical receiver may used by the controller when calculating the range.

The windowing in time may be used to isolate the desired spectral components to be used in the determination of the differential absorption.

According to another embodiment of the invention, there is provided a system and method for imaging gas emissions.

The system may include a laser transmitter responsive to a first control signal to produce a frequency-modulated continuous-wave (FMCW) first optical output and a second control signal to maintain operation nominally at a predetermined optical frequency. The system may also include an optical routing network configured to accept the first optical output and route at least a first portion to a coherent optical receiver, a second portion to a beam scanner, a third portion to a wavelength reference unit, to accept a return signal from the beam scanner, to combine at least a portion of the first portion and the return signal and deliver the combination to the coherent optical receiver, wherein the coherent optical receiver is operable to convert input optical signals into a first electrical signal output. The system may also include an optical receiver within the wavelength reference unit operable to convert the third portion of the first optical output into a wavelength reference signal. The system may also include a controller programmed to generate the first control signal, to accept the wavelength reference signal from the wavelength reference unit, generate the second control signal and deliver the second control signal to the laser transmitter, to accept the first electrical signal output from the coherent optical receiver, and to calculate, using the signal from the coherent optical receiver, a path absorption, wherein either the first or second control signal additionally comprises a component determined by the controller to switch the predetermined optical frequency between at least 2 positions on a predetermined spectral feature of a gas absorption spectrum.

The method may include providing a laser transmitter responsive to a first control signal to produce a frequency-modulated continuous-wave (FMCW) first optical output and a second control signal to maintain operation nominally at a predetermined optical frequency. The method may also include providing an optical routing network, a coherent optical receiver, a beam scanner and a wavelength reference unit, the optical routing network configured to accept the first optical output and route at least a first portion to the coherent optical receiver, a second portion to the beam scanner, a third portion to the wavelength reference unit, to accept a return signal from the beam scanner, to combine at least a portion of the first portion and the return signal and deliver the combination to the coherent optical receiver, wherein the coherent optical receiver is operable to convert input optical signals into a first electrical signal output. The method may also include providing an optical receiver within the wavelength reference unit operable to convert the third portion of the first optical output into a wavelength reference signal. The method may also include providing a controller programmed to generate the first control signal, to accept the wavelength reference signal from the wavelength reference unit, generate the second control signal and deliver the second control signal to the laser transmitter, to accept the first electrical signal output from the coherent optical receiver, and to calculate, using the signal from the coherent optical receiver, a path absorption, wherein either the first or second control signal additionally comprises a component determined by the controller to switch the predetermined optical frequency between at least 2 positions on a predetermined spectral feature of a gas absorption spectrum.

The at least 2 positions on a predetermined spectral feature of a gas absorption spectrum may correspond nominally to inflection points in the absorption-versus-frequency transfer function on either side of the peak absorption frequency. The at least 2 positions on a predetermined spectral feature of a gas absorption spectrum may also correspond to at least one frequency nominally at an inflection point and one frequency nominally at an absorption peak.

The component determined by the controller to switch the predetermined optical frequency may be a nominally square-wave voltage-versus-time waveform.

In calculating a path absorption the controller may form the difference of the first electrical signals corresponding to the at least 2 positions on the predetermined spectral feature.

According to another embodiment of the invention, there is provided a system and method for imaging gas emissions.

The system may include a laser transmitter responsive to a first control signal to produce a frequency-modulated and intensity-modulated continuous-wave (FMCW) first optical output. The system may also include a direct-detection optical receiver configured to sample a fraction of the first optical output to produce an intensity-modulation signal. The system may also include an optical routing network configured to accept a remainder of the first optical output and route at least a first portion to a coherent optical receiver, a second portion to a beam scanner, to accept a return signal from the beam scanner, to combine at least a portion of the first portion and the return signal and deliver the combination to the coherent optical receiver, wherein the coherent optical receiver is operable to convert input optical signals into a first electrical signal output. The system may also include a controller programmed to generate the first control signal, to accept the first electrical signal output from the coherent optical receiver and the intensity-modulation signal, and to calculate, using the first electrical signal output from the coherent optical receiver and the intensity-modulation signal, a path absorption.

The method may include providing a laser transmitter responsive to a first control signal to produce a frequency-modulated and intensity-modulated continuous-wave (FMCW) first optical output. The method may also include providing a direct-detection optical receiver configured to sample a fraction of the first optical output to produce an intensity-modulation signal. The method may also include providing an optical routing network, a coherent optical receiver and a beam scanner, the optical routing network configured to accept a remainder of the first optical output and route at least a first portion to the coherent optical receiver, a second portion to the beam scanner, to accept a return signal from the beam scanner, to combine at least a portion of the first portion and the return signal and deliver the combination to the coherent optical receiver, wherein the coherent optical receiver is operable to convert input optical signals into a first electrical signal output. The method may also include providing a controller programmed to generate the first control signal, to accept the first electrical signal output from the coherent optical receiver and the intensity-modulation signal, and to calculate, using the first electrical signal output from the coherent optical receiver and the intensity-modulation signal, a path absorption.

The direct-detection optical receiver may be a power monitor photodetector packaged within the laser transmitter.

The intensity-modulation signal may be generated by a wavelength reference module.

The intensity-modulation signal may also be generated by the coherent optical receiver.

The intensity-modulation signal my also be generated by an optical receiver connected to an additional coupler port in the optical routing unit.

In calculating a path absorption, the controller may use a mathematical description of the interdependence of the first electrical signal output on path absorption and the intensity-modulation signal.

### BRIEF DESCRIPTION OF THE DRAWINGS

FIG. 1 is a block diagram of system for remote imaging of greenhouse gas emissions;

FIG. 2 is graph which shows a spectral absorption line for 10% Methane gas with 90% Nitrogen at normal temperature (290° C.) and pressure (1 Atm.);

FIG. 3 is a block diagram of a detailed example of the optical routing unit;

FIG. 4 depicts a laser drive current or frequency modulation for FMCW Lidar;

FIGS. 5a to 5e is a computer simulation result of a coherent detection system under illustrative operating conditions;

FIGS. 6a to 6d is a simulation of a system with absorption and intensity modulation;

FIGS. 7a to 7d is a simulation of a system with inverted absorption and intensity modulation;

FIGS. 8a to 8e is a simulation of a system with a 3-term approximate triangle wave;

FIG. 9a to 9f depicts sampling and windowing to extract differential absorption; and

FIG. 10a to 10c is a system simulation for laser biased at absorption peak.

### DETAILED DESCRIPTION OF THE INVENTION

Examples of embodiments given in this disclosure are for illustrative purposes only and do not limit the applicability of inventive concepts. While embodiments of the invention have been described and illustrated, such embodiments should be considered illustrative of the invention only. The invention may include variants not described or illustrated in detail herein. Thus, the embodiments described and illustrated herein should not be considered to limit the invention as construed in accordance with the accompanying claims.

Several aspects of the prior art have been presented above to provide a high-level context for the present inventions. In what follows we present a detailed discussion of one preferred embodiment of a coherent FMCW differential absorption spectroscopic scanning (C-DASS) system, including identifying specific challenges that have stood in the way of developing cost-effective and operationally-attractive systems with reasonable performance to identify and quantify trace gasses.

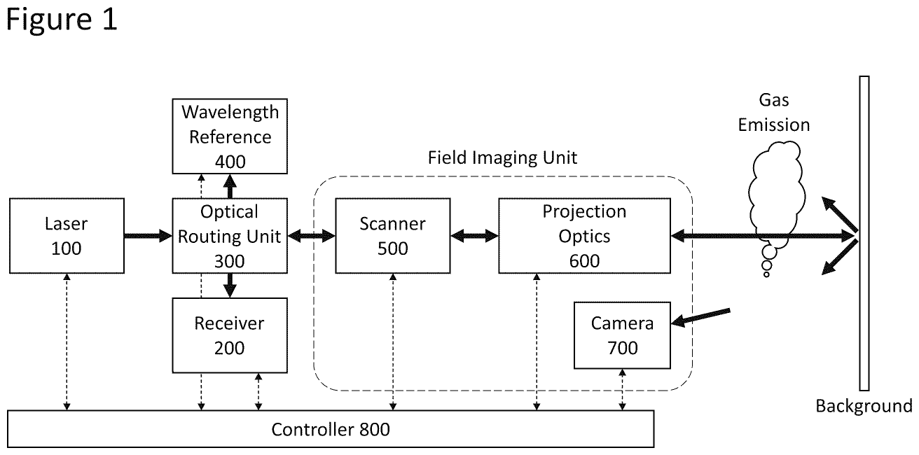

In accordance with the present inventions, C-DASS can be understood with reference to FIG. 1, which illustrates a single-frequency laser diode 100 input to an optical routing unit (“ORU”) 300 which divides the laser output between a wavelength reference module 400, a receiver 200 and a scanner 500. The scanner and projection optics 600 project a portion of the laser output through the spatial volume to be tested to the background and collect a portion of the back-scattered returning light that has double-passed through the suspected gas emission. This returning signal passes back through the ORU which combines this back-scattered light with the portion of the laser output delivered to the receiver.

One embodiment of wavelength reference module 400 comprises a small volume of a gas sample having a known density, generally but not restricted to the gas targeted for imaging. These gas cells are available from multiple vendors in many forms ranging from long (1 m) glass tubes to short (3 cm) sealed units. Light is coupled into the gas cell from a collimated laser beam through a glass window or from a fiber input collimator and may transit the cell length once or multiple times using internal mirrors. After the desired interaction length, the beam is detected with an internal detector, coupled back into fiber through a collimator, or passed out of the cell using a window and detected externally. It may also be useful to know the temperature of the gas in the cell. This can be determined using well-known devices such as a thermistor in close proximity to the gas in the cell. Other embodiments of wavelength reference modules include etalons, used to lock communications lasers to the ITU frequency grid, gas filled hollow-core optical fibers and fiber Bragg gratings, all of which can be designed to be compact and packaged to perform well over wide temperature ranges.

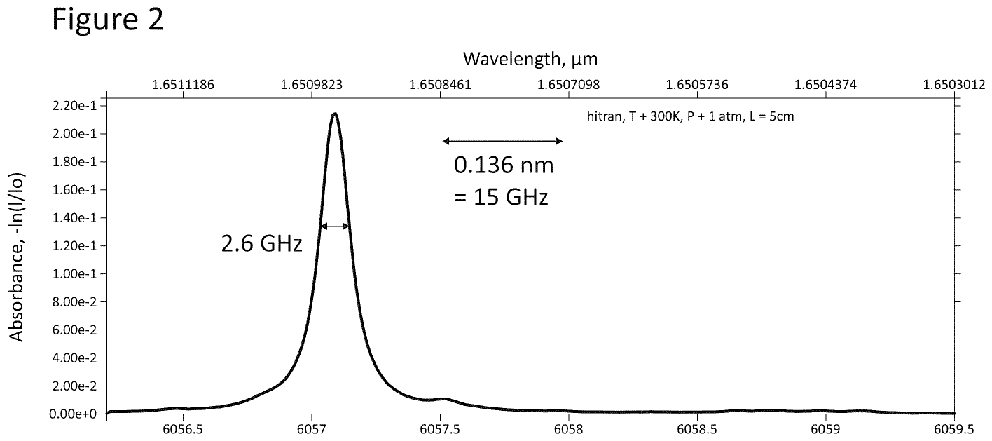

An example of the spectral absorption properties of a gas cell is shown in FIG. 2, taken from the SpectraPlot.com tool using the Hitran data base, well-known resources for spectroscopy. In this example, the cell length is 5 cm and the gas pressure of 1 Atmosphere is comprised of 90% Nitrogen and 10% Methane, conditions for which the linewidth is dominated by collisional broadening resulting in a Lorentzian line shape. For lower pressures, Doppler-broadened line shapes would be narrower with Gaussian distributions. In either case, the absorption-versus-frequency transfer function (“AvF”, or alternatively the absorption-versus-wavelength (“AvW”) transfer function) has inflection points on each side of the mean or peak value—at exactly one standard deviation from the peak for Gaussian or at roughly 0.29 times the full-width at half maximum (“FWHM”) for Lorentzian. For FIG. 2, the FWHM is roughly 4.4 GHz and the separation between inflection points is roughly 2.6 GHz.

In most gas sensing systems, including most WMS and TDLAS systems, the wavelength of a tunable laser is swept across a spectral absorption line. In others, the average laser wavelength is locked to a specific absorption peak and the laser wavelength is modulated about that point. In the C-DASS system, operation with the laser centered on one of the inflection points in the AvF transfer function has several advantages. First, to obtain the strongest signals for weak absorption, these inflection points maximize the slope of the AvF transfer function, maximizing the change in absorption for a given frequency modulation. Second, these points offer convenient properties for active stabilization. The requirement to actively stabilize a laser wavelength to an inflection point is encountered in most modern telecommunications systems. Lasers for each channel in a wavelength-division multiplexed system are locked to inflection points of etalon filters, which have a sinusoidal transmission-versus-wavelength transfer function. Electro-optic modulators, which also have sinusoidal transmission-versus-voltage transfer functions, are routinely locked to an inflection point. Well-known methods are described in, for example, E. Ackerman, et al., “Bias controllers for external modulators in fiber-optic systems,” Lightwave Online, Optical Tech—Electronics, Apr. 30, 2001. While not sinusoidal, similar considerations apply for locking a single-frequency diode laser (e.g., DFB) to AvF inflection points in gas analysis, using a method that involves:
1. using a look-up table of the previously measured dependence of laser frequency on current and temperature to get close to the inflection point,
2. applying a low-frequency modulation at frequency f_{T} to the laser temperature relative to the average temperature,
3. measuring the magnitude and phase of the light intensity transmitted by the wavelength reference cell in response to the temperature-modulated frequency: If the phase corresponds to the desired side of the absorption peak, continue. If not, shift the average temperature by a pre-set amount and repeat 3,
4. measuring the second harmonic at 2f_{T} of the response of the cell output to the temperature modulation at f_{T},
5. using a control loop (e.g., PID) to minimize the second harmonic. This corresponds to the point of inflection.

Alternatively, operating with the laser locked to the peak of the absorption line can be accomplished using well-known control techniques and is used commonly in WMS.

Rather than maximizing the change in absorption for a given frequency modulation, or the slope (first derivative) of the AvF transfer function, operating at the absorption peak maximizes the second derivative of AvF.

As mentioned previously, a preferred scanner 500 uses MEMS technology, although any other scanning technology can be contemplated. A laser output from the ORU 300 is collimated, partially focused or focused onto the scanning mirror which deflects the beam in a desired angle. To scan a 2-dimensional area using a stationary imager, a 2-axis scanning mirror is used. For alternative configurations, including aerial scans from a moving drone, 1-axis scanning may suffice with the motion of the imager providing the other dimension. Three modes of scanning are generally used for 2D scanning. Quasi-static scanning requires that the mirror move to a specific scan angle, then hold this position for a period of time. This is suitable for vector scanning and point target applications, but requires more bandwidth and consideration of settling time at each position. Resonant scanning exploits the mechanical resonance of the mirror and actuator to scan efficiently along a fast axis. This enables high-speed raster scanning. There is usually adequate bandwidth for quasi-static operation on the slow axis. The third scanning mode uses resonant scanning in two dimensions, with frequencies and phases controlled precisely to trace Lissajous patterns filling the 2D field of view (“FoV”). It is well known that there is a trade-off between bandwidth and mirror size. It is also well known that there is a trade-off between beam size, limited by mirror size, and FoV. High-resolution 2D imaging that requires fast scanning and high collection efficiency may benefit from resonant operation on the fast axis or both axes. However, this has consequences when considering speckle and inhomogeneous backgrounds, as discussed later.

In the simple case where the beam is collimated and directed to the MEMS, the projection optics 600 may simply be a window, which offers protection from environmental conditions. The collimated beam then passes directly to the scattering background and collinear back-scattered light is collected. Alternatively, positive and negative focal-length optics may be used to modify beam size (beam expander), or expand FoV (using, for example, a positive and negative focal-length lens pair).

Camera 700 is a useful addition and could be one or more of any other imaging system that is not implementing C-DASS. A preferred embodiment is a low-cost camera such as those used in mobile devices or security cameras. In addition to site surveillance, it provides a high-resolution background image on which the gas absorption information can be superimposed. This would assist in identifying the source of gas emission. Two such cameras separated slightly would provide range information through parallax, independently of the range information extracted from the Lidar capability of the C-DASS system thereby allowing the C-DASS system to be optimized for integrated path absorption (“IPA”) measurement. Camera 700 could also provide imaging of wavelength-specific absorption in a different or complementary IR band.

Controller 800 orchestrates the overall operation, timing, data collection and data processing for the system. It is programmed to generate the control signals, including but not limited to the FMCW modulating waveform, which it passes to the laser to modulate the frequency, and it responds to input from the wavelength reference unit to generate the control signal required to maintain the laser wavelength at the desired point in the absorption spectrum, which it passes to the laser to adjust the average or bias wavelength. Controller 800 is also programmed to receive input from the optical receiver 200 and to calculate the path absorption and range to the scattering background.

Novel aspects of the configuration shown in FIG. 1 include:
1. Relative to the LDAS and WMS systems, which use direct detection, and DIAL systems, the majority of which use direct detection, in FIG. 1 a fraction of the laser output is routed to the receiver for coherent detection. Also, in FIG. 1 the returning scattered signal traverses the same path through the field imaging unit as the outgoing light, whereas in LDAS and DIAL a separate path to a receiver is used.
2. Relative to coherent DIAL systems, the typical approach takes a fraction of the laser output prior to modulation and routes that to the wavelength reference and coherent receiver, then uses an acousto-optic or electro-optic modulator to modulate the frequency of the light sent to the projection optics. In FIG. 1, there is no additional modulator and both the coherent receiver (Local Oscillator, “LO”) and the wavelength reference act on the same modulated signal that is delivered to the field imaging unit. Also, coherent DIAL systems do not use scanners.
3. Relative to coherent scanning FMCW Lidar, the typical approach takes a fraction of the laser output prior to modulation and routes that to the coherent receiver, then uses an acousto-optic or electro-optic modulator to modulate the frequency of the light sent to the projection optics. In FIG. 1 there is no additional modulator and both the coherent receiver (Local Oscillator, “LO”) and the wavelength reference act on the same modulated signal that is delivered to the field imaging unit. Also, there is generally no need for a wavelength reference and the associated control loop as is required in FIG. 1.

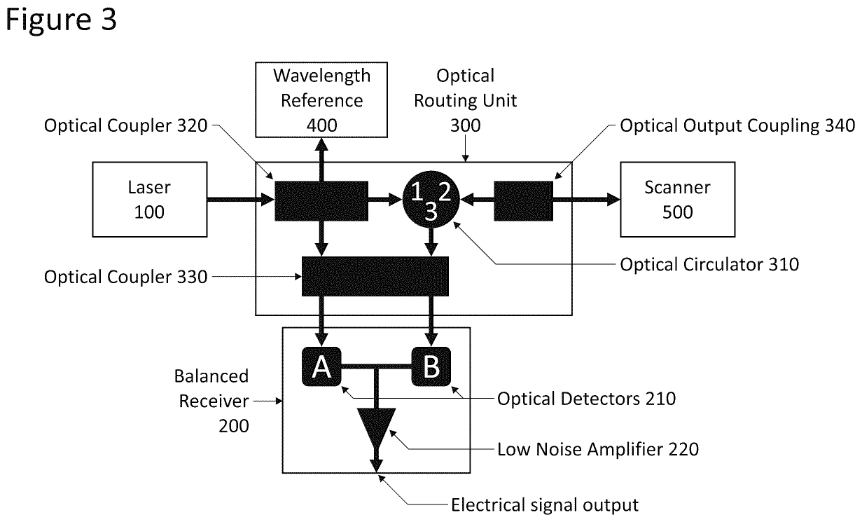

A representative embodiment of ORU 300 is illustrated in FIG. 3. Variants of this configuration are also contemplated that use additional or fewer passive optical components to implement the intended functionality. Coupler 320 divides the output of laser 100 and delivers portions to wavelength reference module 400, circulator 310 and coupler 330. Couplers 320 and 330 and circulator 310 may be implemented using optical-fiber-coupled components or bulk optic components such as beam-splitters, lenses, Faraday rotators, etc., in accordance with well-established practices within the art. Coupler 320 may use a single stage, as in the case of a 1-by-3 fiber coupler, or a sequence of devices like, for example, two beam-splitters in series. Circulator 310 is a highly non-reciprocal component that functions to route inputs to ports 1, 2 and 3 to ports 2, 3 and 1, respectively, with low loss (typically less than 1 dB), while presenting high loss (e.g., 30 dB) from inputs 1, 2, and 3 to ports 3, 1 and 2, respectively. Coupler 330 divides equally optical signals input from coupler 320 and circulator 310 and combines half of the power of each input in each of two outputs. This would be typically a 3-dB beam-splitter or a 3-dB 2-by-2 fused fiber coupler. Output coupling 340 may comprise a collimator to match the optical beam profile between that used for the ORU, (e.g., optical fiber, integrated optical waveguides, collimated optical beams) and that used by the scanner (e.g., collimated or focused beams), or features such as angled facets or multi-layer dielectric or metallic coatings, designed to eliminate or provide specified reflections at the ORU—scanner interface.

Balanced receiver 200 comprises two matched photodetectors 210 (A, B) connected anode-to-cathode with the junction connected to a low-noise amplifier (“LNA”) 220. It is well known that this configuration cancels common-mode relative intensity noise (“RIN”) and intensity modulation (“IM”) from the LO laser while maximizing the detected electrical signal at the output. If RIN and IM are not problems, other configurations with a single detector can be used. To minimize noise added by the LNA, the capacitances of the detectors and LNA input are minimized. Alternatively, if laser intensity noise is tolerable, the balanced receiver 200 can be replaced with a single detector.

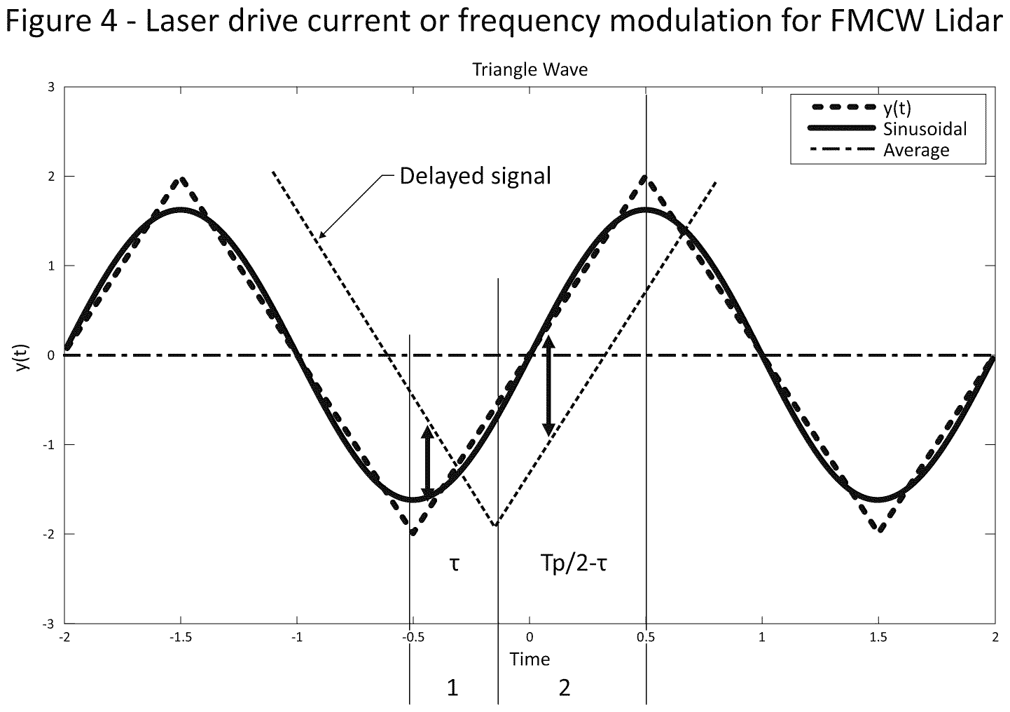

To describe the operation of this embodiment for a C-DASS, consider modulation of the laser current with the triangle waveform illustrated by y(t) in FIG. 4, with a sweep time Tp/2 equal to half the sweep period. Note that a sinusoidal waveform illustrated also on FIG. 4 is a close approximation to the triangle wave and offers an alternative for FMCW Lidar systems (D. Yang et al., “1.55-um coherent Lidar based on SPA sinusoidal frequency demodulation techniques,” Chinese Optics Letters, Col 10(2), 022801, 2012). Generating such triangle waves is straightforward using well-known analog electronic circuits. This waveform and others (e.g., saw-tooth, asymmetric, arbitrary periodic waveforms) can also be synthesized digitally using a suitable mathematical representation and digital-to-analog conversion (DAC). For example, synthesis of a triangle wave begins with its well-known Fourier representation, an infinite series of odd-order sine terms with amplitudes decreasing with increasing frequency, selecting a desired number of terms ranging from 1 (sine wave) to 10 or more frequency components to produce the increasingly close approximation to a perfect triangle wave, then passing the corresponding digital samples to a DAC. This method provides a natural way to compensate for possible frequency dependence of the amplitude and phase response of the laser, by mathematically adjusting the amplitude and phase of each Fourier frequency component prior to the DAC.

It is well known that direct modulation of the laser current around a particular bias current I_{b} for a laser with threshold current Iₜₕ results in modulation of both amplitude (or intensity, IM) and frequency (FM) of the laser output. For most laser diodes operated under a wide variety of conditions the modulation of intensity is an approximately linear function of the current, in parallel with the nearly linear light intensity-versus-current characteristic. Departures from this ideal behaviour are apparent at low modulation frequencies (e.g., less than 100 KHz), where thermal effects dominate, and at higher frequencies (e.g., greater than 1 GHz), where laser dynamics are complicated by the laser relaxation oscillation resonance (P. Iannone, T. E. Darcie, “Multichannel intermodulation distortion in high-speed GaInAsP lasers,” Electronics Letters, Vol. 23, Iss. 25, p. 1361-1362, 3 Dec. 1987). Intensity modulation (IM) ΔL, relative to average intensity Lₒ, is generally described by a modulation

$$m = \frac{Δ i}{( {I}_{b} - {I}_{t h )}} = \frac{Δ L}{{L}_{o}} ,$$

for modulation current Δi.

Frequency modulation is somewhat more complicated, due to thermal effects and spatial hole burning in single-frequency lasers, but since we are concerned with operation over a narrow range of modulation frequencies, we can assume a simple linear FM-versus-current characteristic, described by an FM modulation efficiency η_{f}=Δf/Δi, where Δf is the frequency change resulting from Δi.

Including the effects of IM and FM, the electric field of the laser output can be described by:

$$E ( t ) = {E}_{o} \sqrt{1 + m ( t )} cos ( {ω}_{o} t + φ ( t ) ) , \qquad ( 1 )$$

where Eₒ is normalized such that Eₒ²/2 is the average optical power, where we ignore the typical frequency-dependent phase shift between IM and FM, modulation m(t) has zero mean, ωₒ is the average optical frequency and φ(t) includes all other factors that affect the optical phase, including frequency or phase modulation and phase noise. Upon square-law detection in a photodetector, the optical intensity is:

$${E ( t )}^{2} = \frac{1}{2} {E}_{o}^{2} ( 1 + m ( t ) ) = {L}_{o} ( 1 + m ( t ) ) . \qquad ( 2 )$$

In operation of the C-DASS, a portion of this laser signal is divided equally by coupler 330 and passed by the ORU to each of detectors 210 (A and B) as the local oscillator (LO), along with the weak equally-divided signal returning from the remote scattering background through port 2 to port 3 of circulator 310. The return signal is delayed in time by τ, as shown by the broken curve on FIG. 4.

At detector A, the combined fields of the LO and delayed returning signal can be described by:

$${E}_{A} ( t ) = {E}_{loA} \sqrt{1 + m ( t )} cos ( {ω}_{o} t + φ ( t ) + \frac{π}{2} ) + {E}_{loA} T ( t - τ ) \sqrt{1 + m ( t - τ )} cos ( {ω}_{o} ( t - τ ) + φ ( t - τ ) ) , \qquad ( 3 a )$$

and at detector B by:

$${E}_{B} ( t ) = {E}_{loB} \sqrt{1 + m ( t )} cos ( {ω}_{o} t + φ ( t ) ) + {E}_{loB} T ( t - τ ) \sqrt{1 + m ( t - τ )} cos ( {ω}_{o} ( t - τ ) + φ ( t - τ ) + \frac{π}{2} ) . \qquad ( 3 b )$$

Factors of π/2 are introduced to satisfy power conservation, as is well known in the art for 90-degree microwave hybrids and optical beam-splitters. E_{loA}=E_{IoB}=\sqrt{Lₗₒ}, where Lₗₒ is the total optical power allocated to the two local oscillators at A and B. Returning signals are delayed in time by z and reduced in amplitude by the transmission factor T relative to the LO, where T includes the efficiency of background scattering at the instantaneous location of the scanned beam, the capture efficiency of the collection optics and frequency-dependent (hence time-dependent) absorption of light by the suspect gasses.

Note that in most coherent systems the LO laser is not modulated. Rather, the LO is a well-defined and stable reference signal for detecting the relative phase information between a signal and a LO. In the case of C-DASS, the reference signal is modulated and the desired phase information is obtained by comparing LO and signals delayed in time. This type of time-differential detection has been used for decades (e.g., T. E. Darcie, “Differential frequency-deviation multiplexing for lightwave networks,” J. Lightwave Tech., 7 (2), 314-32, 1989) and is fundamental to FMCW Lidar.

Assuming m(t) is small, square-law detection of the E-field signals at A and B results in currents:

$${i}_{A} ( t ) = \frac{{R}_{o} {L}_{lo}}{2} ( 1 + m ( t ) ) + {R}_{o} {L}_{lo} T ( t - τ ) ( 1 + \frac{m ( t )}{2} + \frac{m ( t - τ )}{2} ) cos ( {ω}_{o} τ + φ ( t ) - φ ( t - τ ) + \frac{π}{2} ) , \qquad ( 4 a )$$

$${i}_{B} ( t ) = \frac{{R}_{o} {L}_{lo}}{2} ( 1 + m ( t ) ) + {R}_{o} {L}_{lo} T ( t - τ ) ( 1 + \frac{m ( t )}{2} + \frac{m ( t - τ )}{2} ) cos ( {ω}_{o} τ + φ ( t ) - φ ( t - τ ) - \frac{π}{2} ) . \qquad ( 4 b )$$

Rₒ is the photodetector responsivity (A/W) terms of order T² can be ignored since T is small. Note that for small T the total received DC power is from Lₗₒ. This assumes that the states of polarization (“SoPs”) are aligned. If the signal and LO SoPs are not matched, the cross-product cosine terms fade, ultimately to zero if SoPs are orthogonal. Many techniques have been developed to address this challenge. Special polarization maintaining (“PM”) fiber can be used to force operation in a known fiber axis, and special connectors, PM couplers, PM circulators, filters, etc., are available to engineer systems to remain in a known SoP. Alternatively, polarization diversity techniques provide for detection of each orthogonal SoP separately, then combining the two outputs such that a signal is generated regardless of the received SoP. Another approach is using electro-mechanical polarization controlling devices like fiber squeezers to actively control the SoP in response to a control signal. Polarization scrambling is another approach, in which electro-mechanical polarization controlling devices are used to randomize the received SoP on some time scale such that on average the signal is reduced, but deep polarization fades are eliminated. Using these techniques and others, the polarization challenge is generally managed. However, this comes with added cost, complexity, and/or at the expense of performance. For example, PM fiber patch cables cost roughly twice the standard fiber cables. For PM circulators and PM couplers the premium is higher.

Two additional challenges are evident from the form of Eqns. (4). The Direct-detected LO and IM (“DD-LO, IM”), described by the first term in each equation, is much larger than the term containing the desired signal T, since T is generally very small. Managing this DD-LO is necessary in order to effectively extract these weak signals using practical digital sampling and signal processing techniques. This DD-LO also adds shot noise that will ultimately limit our system performance, as well as intensity noise, as discussed later. Related to the DD-LO, DD-IM arises from the intensity modulation m(t) on the LO, which accompanies the FM via current modulation. This appears both in the DD-LO,IM term and in the mixing product containing the absorption signal, complicating the extraction of frequency absorption information, which is synchronous with m(t).

Balanced detection offers a first step in mitigating the DD-LO by providing the signal current as the difference between currents A and B, given by:

$${i}_{s} ( t ) = 2 {R}_{o} {L}_{lo} T ( t - τ ) ( 1 + \frac{m ( t )}{2} + \frac{m ( t - τ )}{2} ) sin ( {ω}_{o} τ + φ ( t ) - φ ( t - τ ) ) . \qquad ( 5 )$$

Common-mode intensity modulation and intensity noise cancel if balance is good between the A and B detectors. Generally, however, there will be some residual of the first term in Eqns. (4) and this residual must be managed when detecting weak signals.

Eqn. (5) describes a received signal that is a complicated function of IM, frequency/time-dependent absorption, phase/frequency modulation, round-trip time delay and reflectivity for background back-scatter, and phase noise of the laser (included in φ(t)). Our challenge is to recover the appropriate absorption information within T in a practical and cost-effective manner.

With reference to FIG. 4, the delay τ shifts the frequency of the returning light relative to the outgoing light, and the coherent detection shifts this optical frequency difference, shown by the vertical arrows, into an RF current. Using the triangle wave to modulate the optical frequency produces, for periods of time away from the peaks and valleys, a constant RF frequency at a frequency proportional to the delay time and the rate of FM. By measuring this RF frequency one can determine the distance to the target. This is the basic technique used in FMCW Lidar.

Phase term φ(t)=φₘ(t)+φₙ(t) includes phase modulation φₘ, which is related to frequency modulation, and phase noise φₙ which is an unavoidable consequence of spontaneous emission in lasers. Phase noise can be described by a zero-mean random modulation of the optical phase that broadens the laser linewidth to typically near 1 MHz, depending on laser design and operating conditions. This blurs the phase of the sine term in Eqn. (5) and limits resolution and range detection in Lidar systems. One conventional approach to managing phase noise is to limit the delay time τ between the returning signal and LO to less than the coherence time by limiting range. Another is to buy special low-phase-noise lasers at a cost premium. Other approaches, such as the “intradyne” detection used in mainstream optical fiber communications, use digital signal processing to correct for phase noise after detection. For the present instantiation, a laser with a linewidth of Δf=1 MHz has a coherence length of L_{c}=c/(nΔf)=300 m, which is much larger than the round-trip distance of several tens of meters that is typically required when using this invention. Therefore, we ignore phase noise.

Phase modulation follows from the desired triangle wave for frequency modulation. Considering only one straight-line segment away from the peaks and valleys in FIG. 4, the dependence of frequency on time is:

$$ω ( t ) = {ω}_{o} + \frac{2 Δω}{{T}_{p} / 2} t = {ω}_{o} + {m}^{′} t . \qquad ( 6 )$$

The optical phase modulation from this FM is then:

$${φ}_{m} ( t ) = {m}^{′} \int tdt = {m}^{′} \frac{{t}^{2}}{2} + {ϕ}_{o} , \qquad ( 7 )$$

where φₒ is the phase at t=0. From Eqn. (5), then:

$${i}_{s} ( t ) = 2 {R}_{o} {L}_{lo} T ( t - τ ) ( 1 + \frac{m ( t )}{2} + \frac{m ( t - τ )}{2} ) sin ( {ω}_{o} τ - \frac{1}{2} {m}^{′} {τ}^{2} + {m}^{′} τ t + {Δφ}_{n} ( t ) ) , \qquad ( 8 )$$

where Δφₙ(t)=φ(t)−φₙ(t−τ) accounts for phase noise.

A useful approximation can be used when IM changes the signal current much more slowly than the FM, in which case the delay time is small and m′ is large. Then”

$${i}_{s} ( t ) = 2 {R}_{o} {L}_{lo} T ( t ) ( 1 + m ( t ) ) sin ( {φ}_{o} ( τ ) + {m}^{′} τ t + {Δφ}_{n} ( t ) ) , \qquad ( 9 )$$

which describes a sinusoidal RF signal at angular frequency Ω=m′τ, with a phase φₒ that varies as the delay varies and with phase noise. Lidar works by extracting z, which corresponds to range, from this sine term. The magnitude of this RF signal depends on the reflectivity (of the electric field, or square root of power) of the background and gas absorption through T(t), and laser IM through m(t).

This simple picture is complicated by the peaks and valleys in the modulation triangle wave where, with reference to FIG. 4, during time interval 1 of each half cycle the RF frequency changes from −Ω, through 0, to Ω, and for the remainder of the half cycle, Ω is constant.

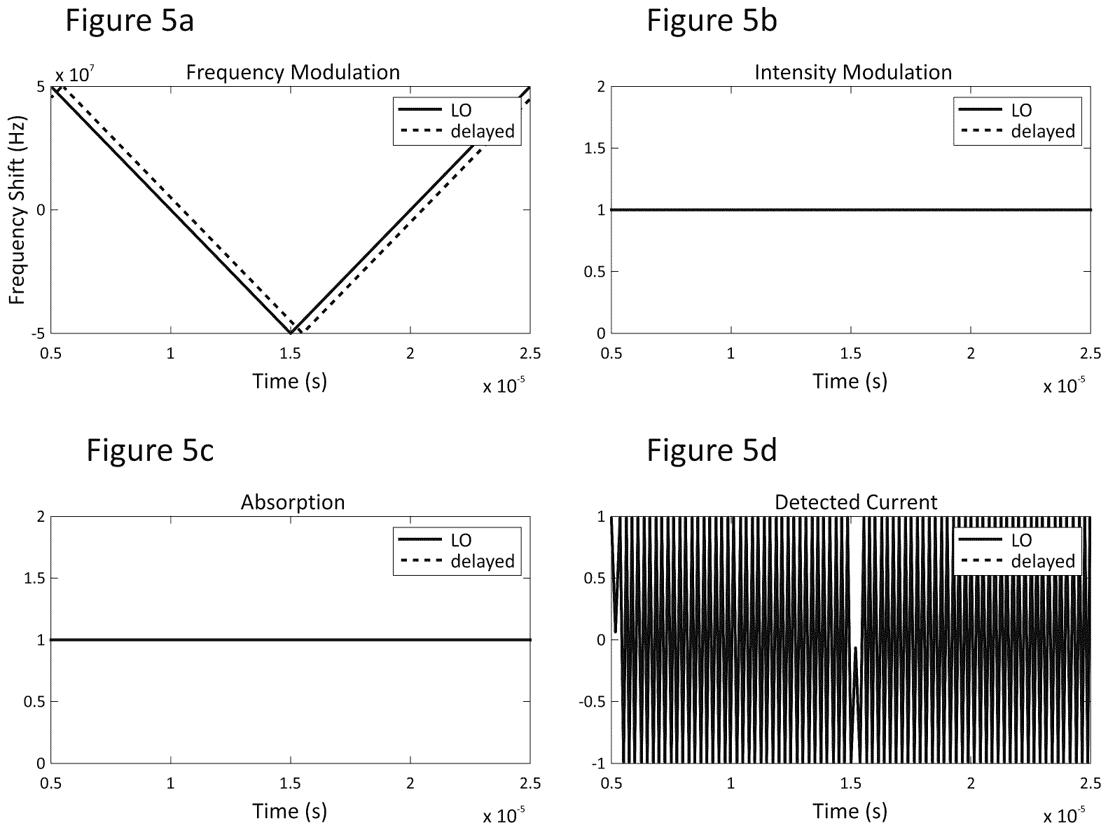

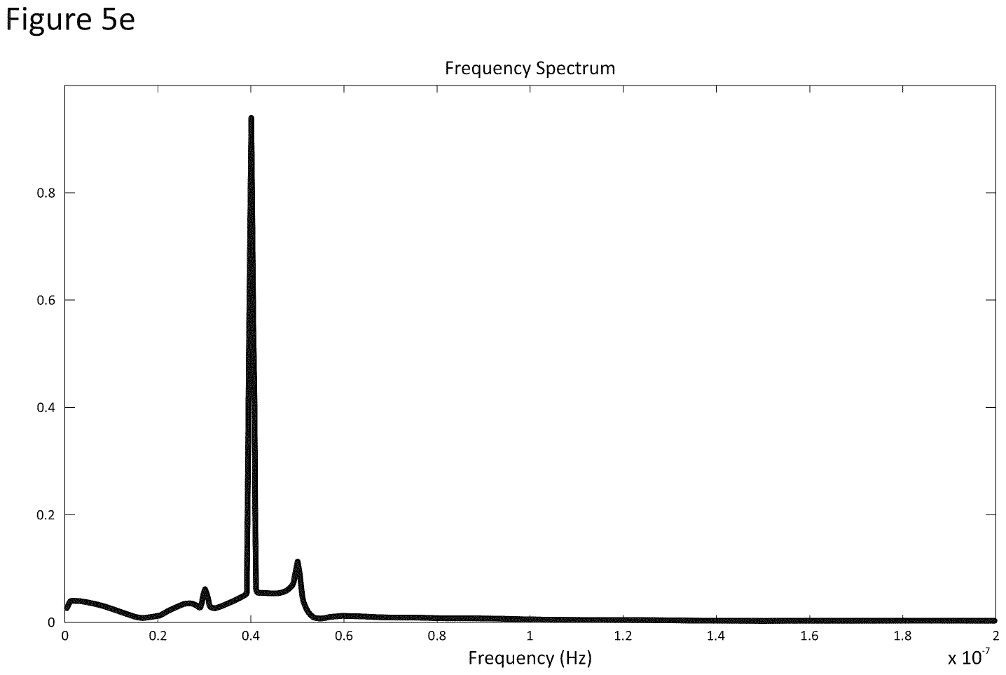

FIG. 5 presents simulation results under illustrative conditions, assuming perfect cancellation of the common-mode DC and IM by the balanced detector and including the desired FM, FIG. (5a), but with no unwanted intensity modulation and no frequency-dependent absorption, as shown by the constant unity levels in FIGS. (5b), (5c). The detected signal current, FIG. (5d), from Eqn. (5) shows the well-defined modulation at frequency n, which is complicated by the turn-around of the modulation ramp. For this example, the triangle wave is synthesized using first 10 Fourier terms, closely approximating the ideal case. The beat frequency is generated by the square-law detection of the direct and delayed frequencies, where the delayed components are shown by the dashed curve in FIG. (5a) (not evident in FIGS. (5b), (5c) given the zero slopes). FIG. (5e) shows the magnitude of the single-sided Fast Fourier Transform (FFT) of the first half of FIG. (5d). A single well-defined RF signal component dominates this spectrum, but also evident are small modulation sidebands corresponding to the imperfections of triangle wave as represented by the truncated series (10 terms). Also present but not resolved are sidebands from the periodic phase modulation caused by the triangle-wave turnarounds.

System conditions for these simulations include:
½ period of triangle wave—10 μs
peak frequency deviation—50 MHz
Round-trip delay τ—0.4 μs
Fourier coefficients describing triangle wave—10

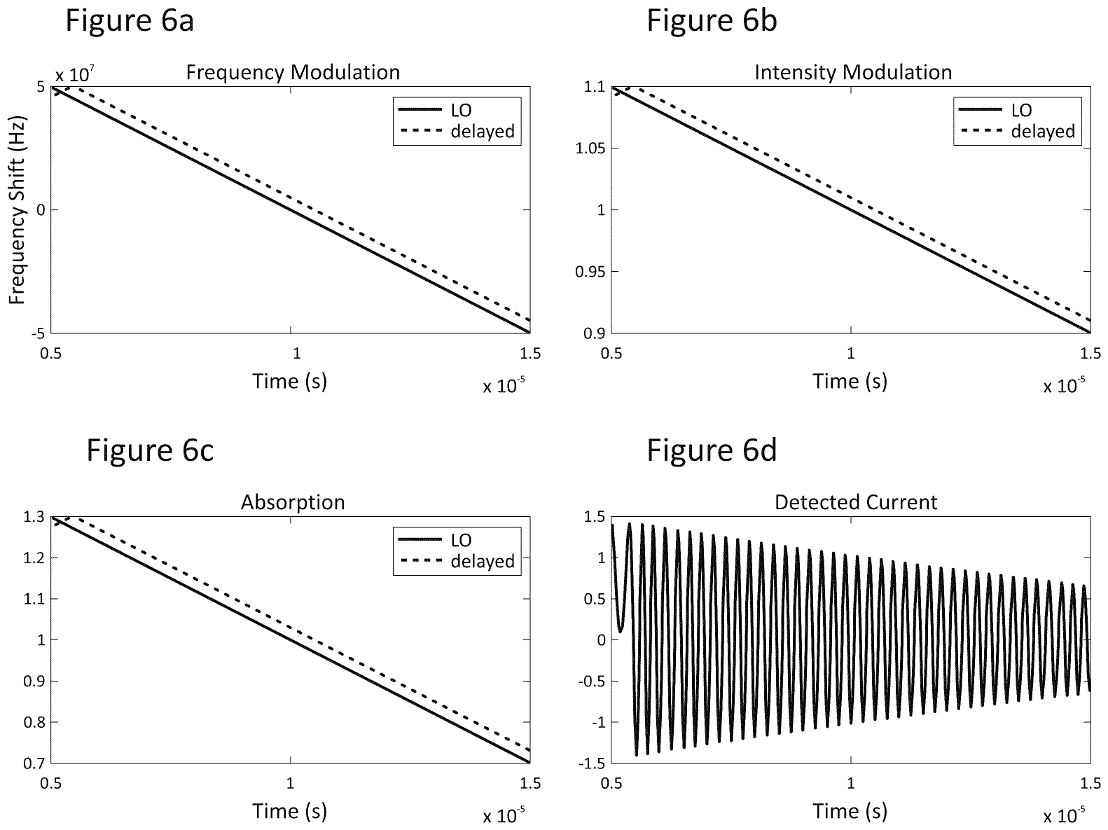

In FIG. 6, absorption and intensity modulation are added. For simplicity, each is assumed to be a linear function of frequency or time, as would be the case for small modulations centered on an inflection point of the AvF transfer function. Conditions are the same as for FIG. 5, but peak IM is now 10% and peak absorption modulation (relative to average) is 30%. Modulation by the combination of IM and absorption is apparent in FIG. (6d), and the dominant RF frequency remains clearly evident. The spectrum (not shown) is approximately indistinguishable from FIG. (5e).

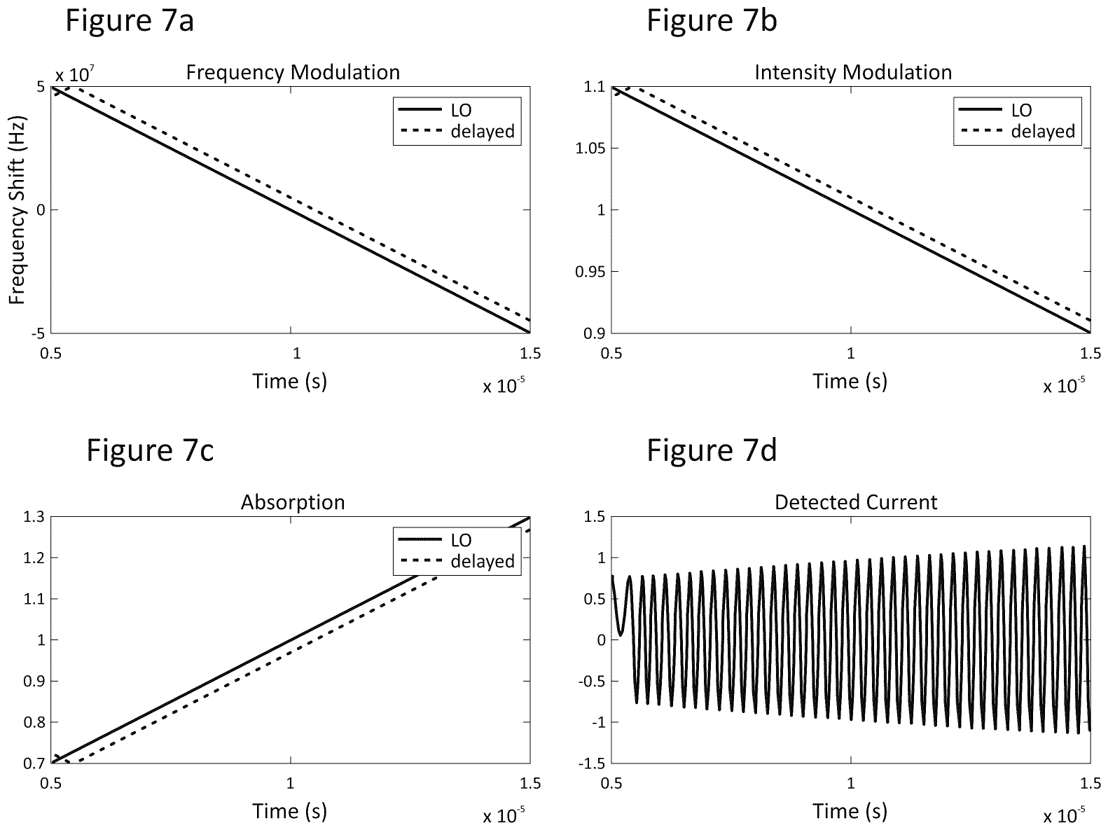

In FIG. 7, the phase of the absorption is inverted, as would be the case if operation were switched to the opposite point of inflection on the AvF. IM and absorption are now in opposition, lessening the overall modulation of the envelope of the RF. Again the spectrum is close to that in FIG. (5e).

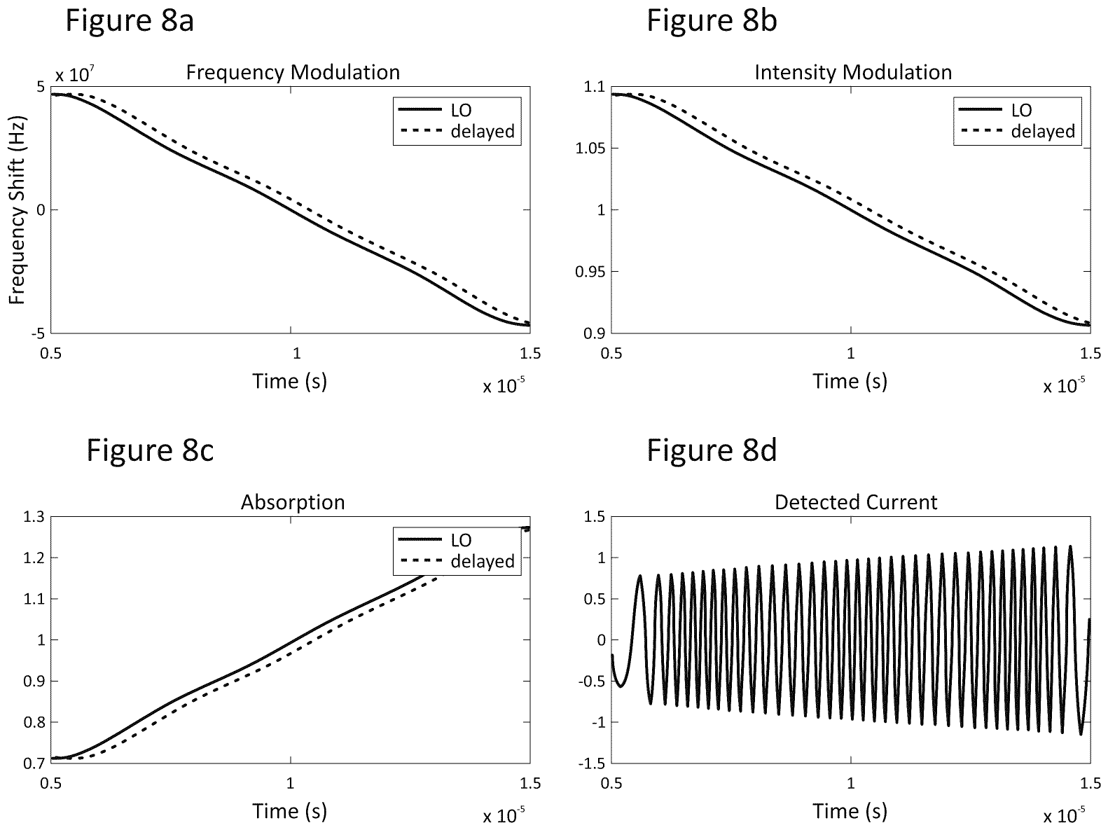

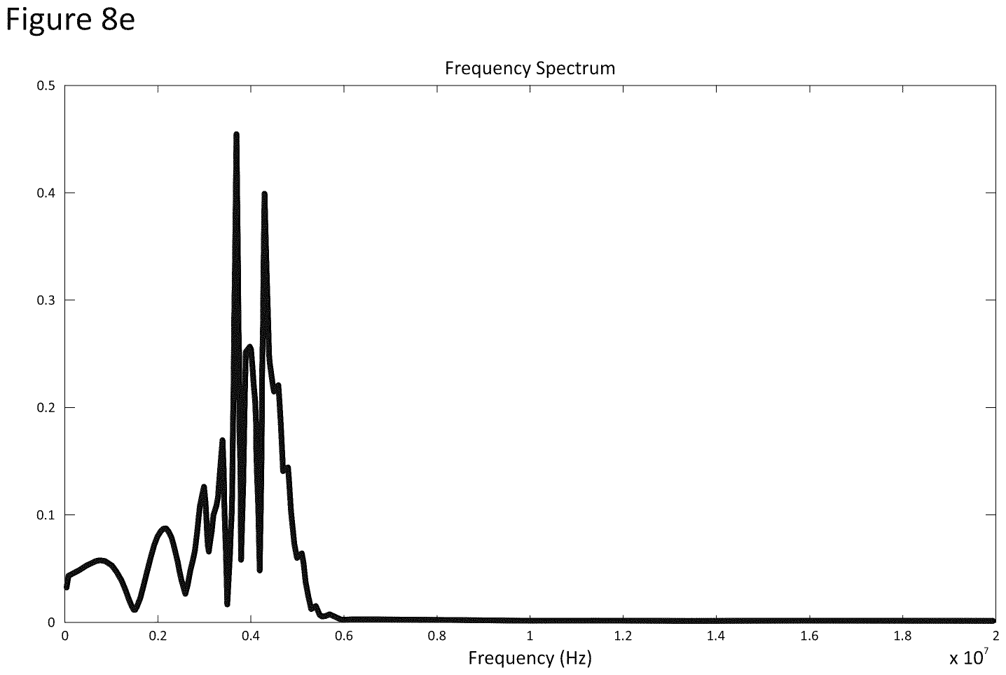

In FIG. 8 we explore the impact of the precision of the triangle-wave driving current by reducing the number of terms in its Fourier representation from 10 to 3. A quick look at FIGS. (8a-c) might suggest that the impact is not significant in either the waveform shape or detected current. However, it is evident from the spectrum in FIG. 8(e) that variations from a perfectly triangular waveform are evident in broadening of the dominant RF beat signal, primarily through additional phase modulation evident in FIG. (8d). This may be tolerable in extracting absorption information, which depends primarily on the RF envelope, but may be more problematic for range information, which relies on determining this beat frequency.

There are many ways to extract range and absorption information from signal traces such as those shown in FIGS. 5-8. An example is presented below.

Absorption information is contained within the amplitude of the RF sine wave and can be calculated without the details of the phase information contained in sine term in Eqn. (5). This amplitude can be calculated from digitally-sampled data, or measured by square-law detection, envelope detection or full-wave rectification of the detected signal. As discussed previously, the magnitude of this RF signal depends on the reflectivity of the background scattering surface and gas absorption through T(t), and laser IM through m(t). In a simple environment, the reflectivity of the background would be constant. In reality, particularly when the laser is scanned across an inhomogeneous background, this reflectivity will be time dependent. For this reason, quasi-stationary scanning, in which the beam is held in a fixed position for the duration of each measurement, may be preferred.

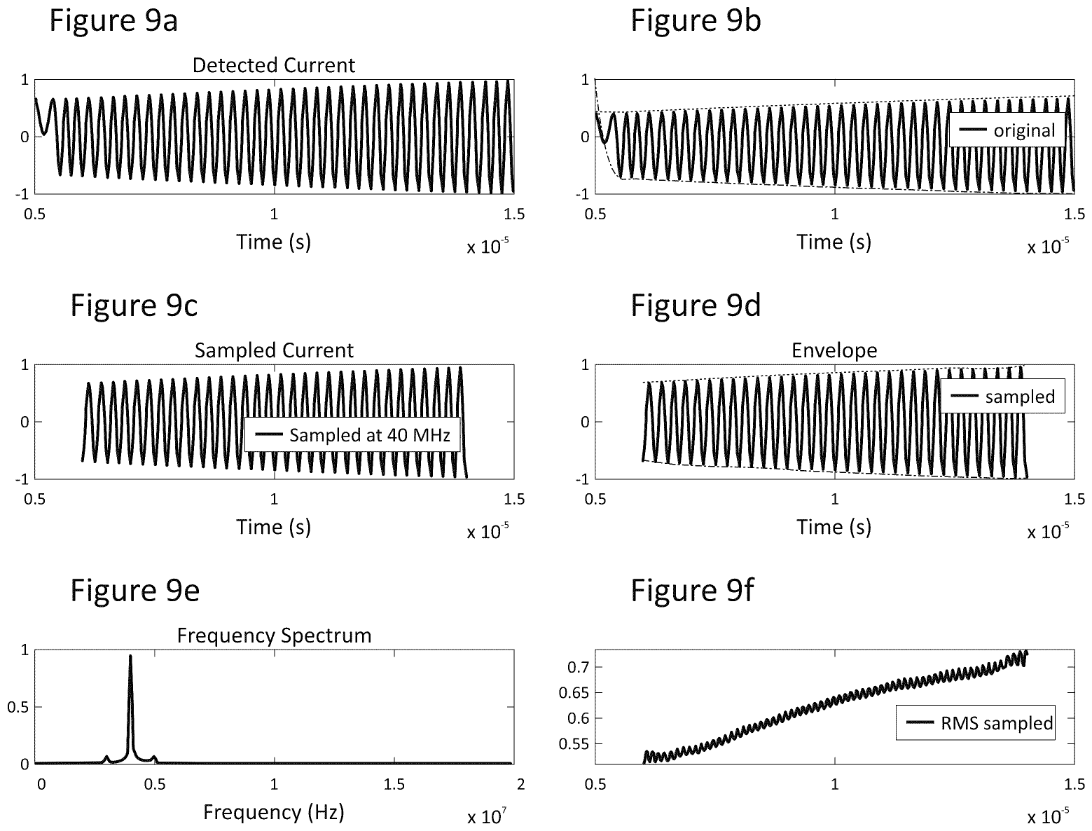

One example of the signal processing follows from FIG. 9. FIG. (9a) shows one half-period of the detected signal current for typical parameters. In this example, we digitally sample the current at 40 MHz, then use an on-off window to remove samples within 10% of the beginning and end of each linear ramp section (FIG. (9a)). Elimination of the signal corresponding to the ramp reversals significantly improves the spectral purity of the RF beat signal seen in FIG. (9c), compared to FIG. (5e), which would help in determining range. It is straightforward to calculate either the envelope or the RMS magnitude of the original (FIG. (9d)) or windowed signal (FIG. (9e, f)). The IM term m(t) can be determined by independent a posteriori measurement. Once IM has been quantified, the time dependence of the absorption can be calculated.

For example, after envelope detection, the dependence of the signal on both m(t) and frequency-dependent absorption m_{ab}(t) is given by:

$${i}_{s} ( t ) = {C}_{1} ( 1 + m ( t ) ) ( 1 + \frac{1}{2} {m}_{ab} ( t ) ) , \qquad ( 10 )$$

where C₁ is a constant (for each scanning beam position) that incorporates all frequency-independent factors and the time variations of m(t) and m_{ab}(t) have frequency components on the order of those of the modulating triangle wave, rather than the much higher RF beat frequency. If the laser center frequency is biased to a point of inflection on the absorption-versus-frequency curve, m_{ab}(t) is approximately linear and modulation of laser current about this point results in the maximum change in absorption per change in frequency, or absorption slope.

Using an additional detector to measure IM directly involves sampling a small fraction of the laser output by one of many means, including but not limited to an additional port on coupler 320, by splitting the signal at the input to wavelength reference 400, and using a monitor photodetector in the package of laser 100. Also, since the returning scattered signals are very weak, a suitable approximation of the IM may be recovered from the low-pass-filtered output (e.g., less than 1 MHz) of one of the detectors 210. Once m(t) and iₛ(t) have been measured, m_{ab}(t) is calculated by inverting Eqn. (10).

Key to this differential approach is the comparison (ratio) of the envelope of the detected RF signal near the start of the frequency modulation waveform with that near the end, where the start may correspond to low absorption and the end to high absorption, or vice versa. This ratio compensates for common factors such as variations in reflectivity of the background and path-length differences that do not change as the frequency is scanned, isolating the differential changes attributable to absorption only.

Another approach to separating the product of m(t) and m_{ab}(t) in Eqn. (10) is to take alternating measurements on opposite slopes of the absorption line and compare results. This can be implemented by adding a square wave to the triangle wave before the DAC waveform synthesis described previously, to periodically shift the laser bias point. The change in bias point must be typically a few GHz, which can be realized by modest changes to the laser current or temperature. This modification of the simple triangle wave, and other variants including saw-tooth, asymmetric and other arbitrary waveforms, applied to a laser or laser output with the primary objective of modulating frequency are contemplated in our definition of FMCW. Each of these approaches can be implemented with limited additional hardware and straightforward signal processing techniques at low bandwidth.

For measurements taken at inflection points on opposite sides of the absorption peak, the sign of the absorption slope m_{ab} is inverted. Each scan provides a different signal current X and Y such that, via Eqn. (10):

$$X ( t ) = {C}_{1 X} ( 1 + {m}_{X} ( t ) ) ( 1 + \frac{1}{2} {m}_{Xab} ( t ) ) , \qquad ( 11 )$$

$$Y ( t ) = {C}_{1 Y} ( 1 + {m}_{Y} ( t ) ) ( 1 - \frac{1}{2} {m}_{Yab} ( t ) ) . \qquad ( 12 )$$

Assuming for simplicity that the IM, absorption and constants for X and Y are equal, and dropping the explicit time dependence, we calculate the sum X+Y and difference X−Y:

$$\sum = 2 {C}_{1} ( 1 + m ) , Δ = {C}_{1} ( 1 + m ) {m}_{ab} = \sum {m}_{ab} / 2. \qquad ( 13 )$$

This provides a straightforward way to decouple IM and absorption by relating the change in absorption directly to the complementary measured signals. In actuality, there may be variations between X and Y and parameters that can be included in the decoupling. In particular, since the IM (m) may be large compared to the change in absorption (m_{ab}), it may be useful to further refine the measured value for m using the additional detector of the prior example.

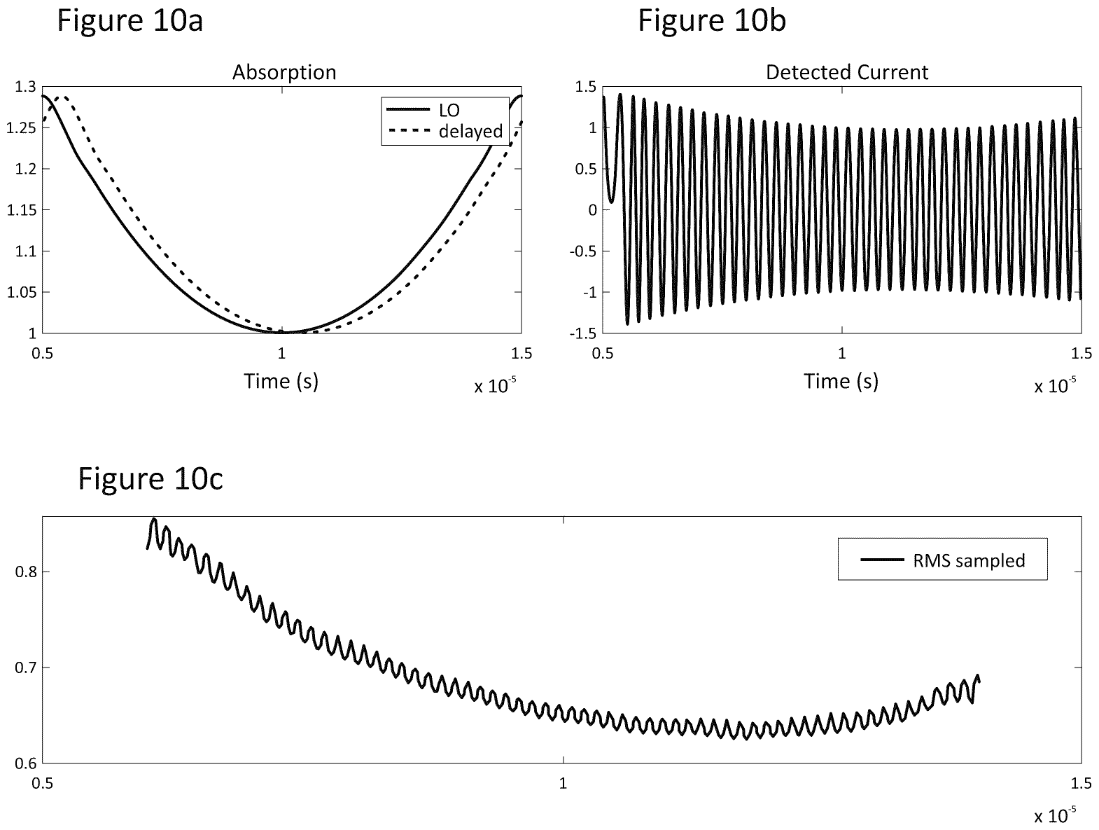

For another embodiment, as mentioned previously, it may be desirable to bias the laser to the peak in the absorption spectrum. This results in an approximately quadratic AvF transfer function. FIG. 10 presents a simulation of this mode of operation. FIG. (10a) shows absorption versus time (LO and delayed) for a center frequency corresponding to the absorption peak (minimum transmission normalized to 1), with an additional IM of 10%. The utility of this operating mode is that absorption is quadratic, while the IM is linear. This is embedded in the signal current (FIG. (10b)). It is possible to extract linear (IM) and quadratic components from RMS (FIG. (10c)) or envelope calculations without prior determination of the IM.

In addition to absorption information contained within the waveform modulation envelope, the range to the background is encoded in the phase of the sinusoidal term, as in traditional FMCW Lidar. To determine range we analyse the frequency content of the trace (e.g., Figure (9c)), typically using an FFT and peak detection algorithm to recover the dominant frequency Ω=m′T, which provides the round trip delay τ, which corresponds to range using Range=cτ/2, where c is the speed of light. Note that this provides range to the background scattering object and not to the gas emission under question, so this may be of limited usefulness in determining IPA. However, frequency-domain analysis of the received signal can also be used to 1) separate desired signal components from those originating from optical reflections within the transmitter, which are generated at low RF frequency relative to those from the distant background, 2) estimate wind speed from Doppler shift of light scattered from dust or droplets entrained in the wind, and 3) facilitate windowing to isolate desired spectral components to be used in the determination of the differential absorption.

A complicating factor is that the back-scattered light does not have a stable well-defined amplitude and phase, as suggested by Eqn. (1) and subsequent analysis. Rather, the returned signal is the sum of a large number of electric-field contributions from individual scattering centers, combining with random phases and varying in time as the environment undergoes mechanical variation or vibration and as the laser is scanned across the FoV. This is the well-known speckle problem, a manifestation of the same phenomenon that creates speckle in many laser-based, hence highly-coherent, imaging systems. Quantifying this set of complex process from an accurate statistical basis is challenging and subject to numerous unknown or variable parameters that are required to describe the detailed surface morphology, optical and mechanical properties, as well as the laser scanning conditions. A simplified understanding can be gained by considering the idealized stationary problem in which a large number N of identical sinusoids (i.e., electric fields from independent scattering centers) are combined with randomly-distributed phase to form the received field Eᵣ. From Eqn. (1) and ignoring IM:

$${E}_{r} ( t ) = {E}_{o} {\sum }_{i = 1}^{N} cos ( {ω}_{o} t + {φ}_{i} ) . \qquad ( 14 )$$

The statistics of this simplified process are well understood (see, for example, T. K. Stanton et al., “Echo statistics associated with discrete scatterers: A tutorial on physics-based methods,” Journal of the Acoustical Society of America 144, 3124, 2018). The probability distribution function (PDF) of the sum is a Gaussian distribution with zero average. As N approaches infinity, the PDF of the magnitude of the total field approaches a Rayleigh distribution:

$${P}_{Ray} ( {E}_{r} ) = \frac{2 {E}_{r}}{〈 {E}_{r}^{2} 〉} {e}^{- {E}_{r}^{2} / 〈 {E}_{r}^{2} 〉} , \qquad ( 15 )$$

where [symbol] Eᵣ² [symbol] ^{1/2} is the rms level for Eᵣ. From Eqn. (15), there is zero probability that the magnitude is zero, corresponding to all components destructively interfering, a maximum probability of magnitude [symbol] Eᵣ² [symbol] ^{1/2}/\sqrt{2}, and a long tail tending to zero for larger magnitudes, corresponding to increasingly lower chances that more field components add constructively. Therefore, we can expect that each stationary measurement would produce an output signal subject to this Rayleigh distribution. To uncover meaningful absorption information, signals must be averaged over multiple independent samples. However, the system contemplated herein may not be stationary, with vibrations, atmospheric motion and beam scanning continuously stirring the ensemble of scattered and received phases at a rate faster than a typical measurement rate, such that, depending on system parameters, some degree of averaging is inescapable.

There are two obvious approaches to managing speckle. First, if the system is approximately stationary, one can average the results of multiple measurements. This condition would be applicable to systems using quasi-static MEMS scanning, where the scanning mirror is held in a constant position for the duration of each measurement, and measurements are done quickly enough that the mechanical, acoustic and atmospheric effects are frozen in time. However, quasi-static operation requires higher MEMS bandwidth than resonant operation, which decreases the size or diameter of the micro-mirror, reducing the size of the light collection aperture, which may in turn reduce sensitivity. Second, if the system is highly non-stationary, this averaging already takes place to some degree. Resonant operation may actually help by increasing randomness, allowing for larger apertures and larger beam diameters. In either case, it is difficult to predict the resulting performance and experimental testing is required.

As explained previously, the scattered signal received at the detector is generally quite small, even when the wavelength is off resonance of any spectral absorption line. This depends on the type of scattering surface, distance or range, and optical configuration. Estimates from simple calculations and published results (e.g., I. Ozdur et al., “Single mode collection efficiency enhancement for free space systems using photonic lantern,” Optical Society America, Advanced Photonic Congress, SW3D.5, 2013) suggest typical received optical powers of −70 to −80 dBm for distances of 10 m and for 1 mW (0 dBm) of launched optical power, numbers that are consistent with our measurements. Clearly these low signal levels require special care to detect. With coherent detection, the peak received backscatter signal current in the absence of gas absorption is given by Eqn. (9). Ignoring IM (m(t)=0) gives:

$${i}_{s} ( t ) = 2 {R}_{o} {L}_{lo} T , \qquad ( 16 )$$

Where T is the round trip transmission loss (of electric field) relative to the LO. Fiber loss is negligible (0.2 dB/km), the single-mode fiber is a very precise spatial filter to ensure alignment of the signal and LO for efficient coherent detection, and we assume polarizations are aligned. Then for 80 dB optical power loss (T²), Lₗₒ=0 dBm and Rₒ˜1 A/W, the received RF electrical signal power S=(0.2 uA)²˜4e(-13)A² (per Ω). Note that direct detection of this same received optical signal would result in Sdir˜(1e(-11)A)²=1e(-22)A² (per Ω).

To put these signal strengths in perspective we next consider noise. In the case where roughly 100 MHz bandwidth is required to receive the detected signal current, and post-detection processing reduces this by a factor of 100, the noise bandwidth is 1 MHz. A reasonable amplified balanced detector has a noise current of less than 10 pA/\sqrt{H}, resulting in receiver noise power (per Ω)=1e(-16)A². For this example, the ratio of signal to receiver noise power is 26 dB. Shot noise is created by the strong LO and has power=2qPₗₒBRₒ=3e(-16)A² (per Ω), where q is the electronic charge. Shot noise power exceeds receiver noise. This is the best we can do as further increasing LO power does not improve the signal-to-noise ratio. The ratio of signal to shot noise=21 dB. Balanced detection will suppress RIN by at least 20 dB, so RIN should not be a problem.

It has been shown that careful selection of the appropriate components and operating parameters can result in reception of backscattered signals in the absence of gas absorption with a signal to noise ratio of roughly 20 dB. This leaves sufficient headroom for differential detection of on-resonance signals weakened by gas absorption and speckle, with broad opportunities for innovative improvements and proprietary enhancements.

A preferred embodiment of a C-DASS imager has been described. It is understood that many variants of aspects of this implementation can be contemplated by one skilled in the art while preserving the intended scope of the invention, including but not limited to the preceding examples. Other mechanisms for generating the required FM waveforms can be contemplated, including the use of external modulators, for example Lithium-Niobate intensity and phase modulators, RF sideband techniques and acousto-optic devices. Any optical wavelength that aligns with a suitable absorption feature can be used. Optical interconnections can be based on free-space, fiber, or integrated optical technology like silicon photonics. A variety of scanning technologies can be considered, including all forms of mechanical, micro-mechanical (MEMS), electro-optic, phased array, acousto-optic, and 1 D or 2D scanners. Projection optics can use collimated, focused, expanded, reduced, or wide FoV beam configurations. Bandwidths, scan rates, parameter values and dimensions described above are merely representative and may vary widely.

We claim:

1. A system for imaging gas emissions, comprising:
a laser transmitter responsive to a first control signal to produce a frequency-modulated continuous-wave (FMCW) first optical output;
an optical routing network configured to accept the first optical output and route at least a first portion to a coherent optical receiver and a second portion to a beam scanner, to accept a return signal from the beam scanner, and to combine at least a portion of the first portion and the return signal and deliver the combination to the coherent optical receiver, wherein the coherent optical receiver is operable to convert input optical signals into a first electrical signal output; and
a controller programmed to generate the first control signal and to accept the first electrical signal output from the coherent optical receiver, and to calculate, using the first electrical signal from the coherent optical receiver, a path absorption.

2. The system for imaging gas emissions according to claim 1 wherein the FMCW first optical output is generated using direct modulation of the current injected into a laser diode.

3. The system for imaging gas emissions according to claim 1 wherein the FMCW first optical output is generated using external modulation of a continuous-wave laser.

4. The system for imaging gas emissions according to claim 3 wherein the external modulation of a continuous-wave laser is implemented using an acousto-optic frequency modulator.

5. The system for imaging gas emissions according to claim 1 wherein the first control signal is nominally a triangle or saw-tooth waveform.

6. The system for imaging gas emissions according to claim 1 wherein the first control signal is nominally a sinusoidal waveform.

7. The system for imaging gas emissions according to claim 1 wherein the first control signal is the sum of a finite number of Fourier frequency components and wherein the amplitude and phase of each component is adjusted to compensate for laser characteristics.

8. The system for imaging gas emissions according to claim 1 wherein the controller is also programmed to compute, using the signal from the coherent optical receiver, the range to the scattering background.

9. The system for imaging gas emissions according to claim 1 wherein calculating a path absorption, the controller measures the amplitude, envelope or root-mean square of the first electrical signal output from the coherent optical receiver.

10. A system for imaging gas emissions, comprising:
a laser transmitter responsive to a first control signal to produce a frequency-modulated continuous-wave (FMCW) first optical output and a second control signal to maintain operation nominally at a predetermined optical frequency;
an optical routing network configured to accept the first optical output and route at least a first portion to a coherent optical receiver, a second portion to a beam scanner, a third portion to a wavelength reference unit and to accept a return signal from the beam scanner, to combine at least a portion of the first portion and the return signal and deliver the combination to the coherent optical receiver wherein the coherent optical receiver is operable to convert input optical signals into a first electrical signal output;
a second optical receiver within the wavelength reference unit operable to convert the third portion of the first optical output into a wavelength reference signal; and
a controller programmed to generate the first control signal, to accept the wavelength reference signal from the wavelength reference unit, generate the second control signal and deliver the second control signal to the laser transmitter, to accept the first electrical signal output from the coherent optical receiver, and to calculate, using the signal from the coherent optical receiver, a path absorption.

11. The system for imaging gas emissions according to claim 10 wherein the second control signal is used to maintain operation at an optical frequency corresponding to a predetermined spectral feature of a gas absorption spectrum.

12. The system for imaging gas emissions according to claim 11 wherein the predetermined spectral feature corresponds to an inflection point in the absorption-versus-frequency transfer function.

13. The system for imaging gas emissions according to claim 11 wherein the predetermined spectral feature corresponds to a peak in the absorption-versus-frequency transfer function.

14. The system for imaging gas emissions according to claim 10 wherein generating the second control signal, the controller compares the signals at the FMCW modulation frequency and at 2 times the FMCW modulation frequency.

15. The system for imaging gas emissions according to claim 10 wherein the wavelength reference unit comprises a sample of the gas that is to be imaged.

16. A system for imaging gas emissions, comprising:
a laser transmitter responsive to a first control signal to produce a frequency-modulated continuous-wave (FMCW) first optical output;
an optical routing network configured to accept the first optical output and route at least a first portion to a coherent optical receiver, a second portion to a beam scanner, and to accept a return signal from the beam scanner, to combine at least a portion of the first portion and the return signal and deliver the combination to the coherent optical receiver, wherein the coherent optical receiver is operable to convert input optical signals into a first electrical signal output; and
a controller programmed to generate the first control signal, to accept the first electrical signal output from the coherent optical receiver and to calculate, using the first electrical signal output from the coherent optical receiver, a path absorption and range, where, in calculating the path absorption, the controller compares the signal from the coherent receiver at different times within at least one period of the FMCW first optical output.

17. The system for imaging gas emissions according to claim 16 wherein the amplitude of the signal from the coherent optical receiver is used by the controller in calculating the path absorption.

18. The system for imaging gas emissions according to claim 16 wherein the controller further calculates the range to the scattering background using the signal from the coherent optical receiver corresponding to at least one time within at least one period of the FMCW first optical output.

19. The system for imaging gas emissions according to claim 20 wherein the amplitude of the signal from the coherent optical receiver is used by the controller when calculating the range.

20. The system for imaging gas emissions according to claim 18 wherein the frequency of the signal from the coherent optical receiver is used by the controller when calculating the range.

21. The system for imaging gas emissions according to claim 16, wherein windowing in time is used to isolate the desired spectral components to be used in the determination of the differential absorption.

22. A system for imaging gas emissions, comprising:
a laser transmitter responsive to a first control signal to produce a frequency-modulated continuous-wave (FMCW) first optical output and a second control signal to maintain operation nominally at a predetermined optical frequency;
an optical routing network configured to accept the first optical output and route at least a first portion to a coherent optical receiver, a second portion to a beam scanner, a third portion to a wavelength reference unit, to accept a return signal from the beam scanner, to combine at least a portion of the first portion and the return signal and deliver the combination to the coherent optical receiver, wherein the coherent optical receiver is operable to convert input optical signals into a first electrical signal output;
an optical receiver within the wavelength reference unit operable to convert the third portion of the first optical output into a wavelength reference signal; and
a controller programmed to generate the first control signal, to accept the wavelength reference signal from the wavelength reference unit, generate the second control signal and deliver the second control signal to the laser transmitter, to accept the first electrical signal output from the coherent optical receiver, and to calculate, using the signal from the coherent optical receiver, a path absorption, wherein either the first or second control signal additionally comprises a component determined by the controller to switch the predetermined optical frequency between at least 2 positions on a predetermined spectral feature of a gas absorption spectrum.

23. The system for imaging gas emissions according to claim 22 wherein the at least 2 positions on a predetermined spectral feature of a gas absorption spectrum correspond nominally to inflection points in the absorption-versus-frequency transfer function on either side of the peak absorption frequency.

24. The system for imaging gas emissions according to claim 22 wherein the at least 2 positions on a predetermined spectral feature of a gas absorption spectrum correspond to at least one frequency nominally at an inflection point and one frequency nominally at an absorption peak.

25. The system for imaging gas emissions according to claim 22 wherein the component determined by the controller to switch the predetermined optical frequency comprises a nominally square-wave voltage-versus-time waveform.

26. The system for imaging gas emissions according to claim 22 where in calculating a path absorption the controller forms the difference of the first electrical signals corresponding to the at least 2 positions on the predetermined spectral feature.

27. A system for imaging gas emissions, comprising:
a laser transmitter responsive to a first control signal to produce a frequency-modulated and intensity-modulated continuous-wave (FMCW) first optical output;
a direct-detection optical receiver configured to sample a fraction of the first optical output to produce an intensity-modulation signal;
an optical routing network configured to accept a remainder of the first optical output and route at least a first portion to a coherent optical receiver, a second portion to a beam scanner, to accept a return signal from the beam scanner, to combine at least a portion of the first portion and the return signal and deliver the combination to the coherent optical receiver, wherein the coherent optical receiver is operable to convert input optical signals into a first electrical signal output; and
a controller programmed to generate the first control signal, to accept the first electrical signal output from the coherent optical receiver and the intensity-modulation signal, and to calculate, using the first electrical signal output from the coherent optical receiver and the intensity-modulation signal, a path absorption.

28. The system for imaging gas emissions according to claim 27 wherein the direct-detection optical receiver comprises a power monitor photodetector packaged within the laser transmitter.

29. The system for imaging gas emissions according to claim 27 wherein the intensity-modulation signal is generated by a wavelength reference module.

30. The system for imaging gas emissions according to claim 27 wherein the intensity-modulation signal is generated by the coherent optical receiver.

31. The system for imaging gas emissions according to claim 27 wherein the intensity-modulation signal is generated by an optical receiver connected to an additional coupler port in the optical routing unit.

32. The system for imaging gas emissions according to claim 27 wherein calculating a path absorption, the controller uses a mathematical description of the interdependence of the first electrical signal output on path absorption and the intensity-modulation signal.

33. A method for imaging gas emissions, comprising:
providing a laser transmitter responsive to a first control signal to produce a frequency-modulated continuous-wave (FMCW) first optical output;
providing an optical routing network, a coherent optical receiver and a beam scanner, the optical routing network configured to accept the first optical output and route at least a first portion to the coherent optical receiver and a second portion to the beam scanner, to accept a return signal from the beam scanner, and to combine at least a portion of the first portion and the return signal and deliver the combination to the coherent optical receiver, wherein the coherent optical receiver is operable to convert input optical signals into a first electrical signal output; and
providing a controller programmed to generate the first control signal and to accept the first electrical signal output from the coherent optical receiver, and to calculate, using the first electrical signal from the coherent optical receiver, a path absorption.

34. The method for imaging gas emissions according to claim 33 wherein the FMCW first optical output is generated using direct modulation of the current injected into a laser diode.

35. The method for imaging gas emissions according to claim 33 wherein the FMCW first optical output is generated using external modulation of a continuous-wave laser.

36. The method for imaging gas emissions according to claim 35 wherein the external modulation of a continuous-wave laser is implemented using an acousto-optic frequency modulator.

37. The method for imaging gas emissions according to claim 33 wherein the first control signal is nominally a triangle or saw-tooth waveform.

38. The method for imaging gas emissions according to claim 33 wherein the first control signal is nominally a sinusoidal waveform.

39. The method for imaging gas emissions according to claim 33 wherein the first control signal is the sum of a finite number of Fourier frequency components and wherein the amplitude and phase of each component is adjusted to compensate for laser characteristics.

40. The method for imaging gas emissions according to claim 33 wherein the controller is also programmed to compute, using the signal from the coherent optical receiver, the range to the scattering background.

41. The method for imaging gas emissions according to claim 33 wherein when calculating a path absorption, the controller measures the amplitude, envelope or root-mean square of the first electrical signal output from the coherent optical receiver.

42. A method for imaging gas emissions, comprising:
providing a laser transmitter responsive to a first control signal to produce a frequency-modulated continuous-wave (FMCW) first optical output and a second control signal to maintain operation nominally at a predetermined optical frequency;
providing an optical routing network, a coherent optical received and a beam scanner, the optical routing network configured to accept the first optical output and route at least a first portion to the coherent optical receiver, a second portion to the beam scanner, a third portion to a wavelength reference unit and to accept a return signal from the beam scanner, to combine at least a portion of the first portion and the return signal and deliver the combination to the coherent optical receiver wherein the coherent optical receiver is operable to convert input optical signals into a first electrical signal output;
providing an optical receiver within the wavelength reference unit operable to convert the third portion of the first optical output into a wavelength reference signal; and
providing a controller programmed to generate the first control signal, to accept the wavelength reference signal from the wavelength reference unit, generate the second control signal and deliver the second control signal to the laser transmitter, to accept the first electrical signal output from the coherent optical receiver, and to calculate, using the signal from the coherent optical receiver, a path absorption.

43. The method for imaging gas emissions according to claim 42 wherein the second control signal is used to maintain operation at an optical frequency corresponding to a predetermined spectral feature of a gas absorption spectrum.

44. The method for imaging gas emissions according to claim 43 wherein the predetermined spectral feature corresponds to an inflection point in the absorption-versus-frequency transfer function.

45. The method for imaging gas emissions according to claim 43 wherein the predetermined spectral feature corresponds to a peak in the absorption-versus-frequency transfer function.

46. The method for imaging gas emissions according to claim 42 wherein generating the second control signal, the controller compares the signals at the FMCW modulation frequency and at 2 times the FMCW modulation frequency.

47. The method for imaging gas emissions according to claim 42 wherein the wavelength reference unit comprises a sample of the gas that is to be imaged.

48. A method for imaging gas emissions, comprising:
providing a laser transmitter responsive to a first control signal to produce a frequency-modulated continuous-wave (FMCW) first optical output;
providing an optical routing network, a coherent optical receiver and a beam scanner, the optical routing network configured to accept the first optical output and route at least a first portion to the coherent optical receiver, a second portion to the beam scanner, and to accept a return signal from the beam scanner, to combine at least a portion of the first portion and the return signal and deliver the combination to the coherent optical receiver, wherein the coherent optical receiver is operable to convert input optical signals into a first electrical signal output; and
providing a controller programmed to generate the first control signal, to accept the first electrical signal output from the coherent optical receiver and to calculate, using the first electrical signal output from the coherent optical receiver, a path absorption and range, where, in calculating the path absorption, the controller compares the signal from the coherent receiver at different times within at least one period of the FMCW first optical output.

49. The method for imaging gas emissions according to claim 48 wherein the amplitude of the signal from the coherent optical receiver is used by the controller in calculating the path absorption.

50. The method for imaging gas emissions according to claim 48 wherein the controller further calculates the range to the scattering background using the signal from the coherent optical receiver at least one time within at least one period of the FMCWfirst optical output.

51. The method for imaging gas emissions according to claim 48 wherein the amplitude of the signal from the coherent optical receiver is used by the controller when calculating the range.

52. The method for imaging gas emissions according to claim 50 wherein the frequency of the signal from the coherent optical receiver is used by the controller when calculating the range.

53. The method for imaging gas emissions according to claim 48, wherein windowing in time is used to isolate the desired spectral components to be used in the determination of the differential absorption.

54. A method for imaging gas emissions, comprising:
providing a laser transmitter responsive to a first control signal to produce a frequency-modulated continuous-wave (FMCW) first optical output and a second control signal to maintain operation nominally at a predetermined optical frequency;
providing an optical routing network, a coherent optical receiver, a beam scanner and a wavelength reference unit, the optical routing network configured to accept the first optical output and route at least a first portion to the coherent optical receiver, a second portion to the beam scanner, a third portion to the wavelength reference unit, to accept a return signal from the beam scanner, to combine at least a portion of the first portion and the return signal and deliver the combination to the coherent optical receiver, wherein the coherent optical receiver is operable to convert input optical signals into a first electrical signal output;
providing an optical receiver within the wavelength reference unit operable to convert the third portion of the first optical output into a wavelength reference signal; and
providing a controller programmed to generate the first control signal, to accept the wavelength reference signal from the wavelength reference unit, generate the second control signal and deliver the second control signal to the laser transmitter, to accept the first electrical signal output from the coherent optical receiver, and to calculate, using the signal from the coherent optical receiver, a path absorption, wherein either the first or second control signal additionally comprises a component determined by the controller to switch the predetermined optical frequency between at least 2 positions on a predetermined spectral feature of a gas absorption spectrum.

55. The method for imaging gas emissions according to claim 54 wherein the at least 2 positions on a predetermined spectral feature of a gas absorption spectrum correspond to frequencies nominally symmetrically separated on either side of the peak absorption frequency.

56. The method for imaging gas emissions according to claim 55 wherein the at least 2 positions on a predetermined spectral feature of a gas absorption spectrum correspond nominally to inflection points in the absorption-versus-frequency transfer function on either side of the peak absorption frequency.

57. The method for imaging gas emissions according to claim 54 wherein the at least 2 positions on a predetermined spectral feature of a gas absorption spectrum correspond to at least one frequency nominally at an inflection point and one frequency nominally at an absorption peak.

58. The method for imaging gas emissions according to claim 54 wherein the component determined by the controller to switch the predetermined optical frequency comprises a nominally square-wave voltage-versus-time waveform.

59. The method for imaging gas emissions according to claim 54 wherein calculating a path absorption the controller compares the first electrical signals corresponding to the at least 2 positions.

60. The method for imaging gas emissions according to claim 54 wherein calculating a path absorption the controller forms the difference of the first electrical signals corresponding to the at least 2 positions on the predetermined spectral feature.

61. A method for imaging gas emissions, comprising:
providing a laser transmitter responsive to a first control signal to produce a frequency-modulated and intensity-modulated continuous-wave (FMCW) first optical output;
providing a direct-detection optical receiver configured to sample a fraction of the first optical output to produce an intensity-modulation signal;
providing an optical routing network, a coherent optical receiver and a beam scanner, the optical routing network configured to accept a remainder of the first optical output and route at least a first portion to the coherent optical receiver, a second portion to the beam scanner, to accept a return signal from the beam scanner, to combine at least a portion of the first portion and the return signal and deliver the combination to the coherent optical receiver, wherein the coherent optical receiver is operable to convert input optical signals into a first electrical signal output; and
providing a controller programmed to generate the first control signal, to accept the first electrical signal output from the coherent optical receiver and the intensity-modulation signal, and to calculate, using the first electrical signal output from the coherent optical receiver and the intensity-modulation signal, a path absorption.

62. The method for imaging gas emissions according to claim 61 wherein the direct-detection optical receiver comprises a power monitor photodetector packaged within the laser transmitter.

63. The method for imaging gas emissions according to claim 61 wherein the intensity-modulation signal is generated by a wavelength reference module.

64. The method for imaging gas emissions according to claim 61 wherein the intensity-modulation signal is generated by the coherent optical receiver.

65. The method for imaging gas emissions according to claim 61 wherein the intensity-modulation signal is generated by an optical receiver connected to an additional coupler port in the optical routing unit.

66. The method for imaging gas emissions according to claim 61 wherein calculating a path absorption, the controller uses a mathematical description of the interdependence of the first electrical signal output on path absorption and the intensity-modulation signal.
